(19) United States
(12) Patent Application Publication
(10) Pub. No.: US 2017/0318180 A1
(43) Pub. Date: Nov. 2, 2017

(54) IMAGE SENSOR UNIT, IMAGE READING APPARATUS, AND IMAGE FORMING APPARATUS

(71) Applicant: CANON COMPONENTS, INC., Kodama-gun, Saitama (JP)

(72) Inventors: Hideo KIYOTA, Saitama (JP); Yohei HIRATSUKA, Saitama (JP); Takashi KOBE, Saitama (JP); Hiroyuki FUJIMURA, Saitama (JP)

(21) Appl. No.: 15/518,277

(22) PCT Filed: Dec. 2, 2015
(86) PCT No.: PCT/JP2015/083861

§ 371 Date: Apr. 11, 2017

(30) Foreign Application Priority Data
Dec. 2, 2014 (JP) 2014-244352

(51) Int. Cl. H04N 1/031; G03B 27/50; H04N 1/10; H04N 1/193

(52) U.S. Cl. CPC H04N 1/031; H04N 1/193; G03B 27/50; H04N 1/1043

(57) ABSTRACT

An image sensor unit (1A) includes: a light condenser (40) that condenses light including image information of an illuminated object; an image sensor (48) that receives the light passed through the light condenser (40) and that converts the light to an electrical signal; and a frame (10A) that houses the light condenser (40) and the image sensor (48), wherein the image sensor unit (1A) includes an urging member (50A) that urges and fixes the light condenser (40) to the frame (45), and the urging member (50A) urges and fixes the light condenser (40) to the frame (10A) from a light entering side or a light emission side of the light.

### TECHNICAL FIELD

The present invention relates to an image sensor unit, an image reading apparatus, and an image forming apparatus.

### BACKGROUND ART

There is a known image sensor unit that causes an image sensor to focus light from a linearly illuminated object to read an image of the illuminated object. Patent Literature 1 discloses an image sensor module that houses a lens unit in a slit of a case, wherein the lens unit couples, with a sensor chip, linear light reflected by a light source. The lens unit disclosed in Patent Literature 1 is housed in the slit and fixed by an adhesive.

### CITATION LIST

### Patent Literature

Patent Literature 1: Japanese Laid-open Patent Publication No. 2009-200913

### SUMMARY OF THE INVENTION

### Technical Problem

However, there is a problem that the image sensor module cannot be easily assembled when the adhesive is used to fix the lens unit as in the image sensor module of Patent Literature 1. Specifically, when the adhesive is used for the fixation, an appropriate amount of adhesive needs to be applied. When the amount of adhesive is too large, the adhesive sticks out and affects other members. When the amount of adhesive is too small, the lens unit cannot be sufficiently fixed. Furthermore, the viscosity of the adhesive may vary depending on the manufactured rod or the temperature, and management of the adhesive is necessary.

An adhesion system requires application time for applying the adhesive and curing time for curing the adhesive, and it is difficult to improve the reproduction efficiency. Since different materials are bonded and fixed, the image sensor unit is warped by internal stress caused by thermal expansion, humidity expansion difference, and the like.

The present invention has been made in view of the problems, and an object of the present invention is to provide an image sensor unit and the like that can easily assemble a light condenser to a frame.

### Solution to Problem

The present invention provides an image sensor unit including: a light condenser that condenses light including image information of an illuminated object; an image sensor that receives the light passed through the light condenser and that converts the light to an electrical signal; and a frame that houses the light condenser and the image sensor, wherein the image sensor unit includes an urging member that urges and fixes the light condenser to the frame, and the urging member urges and fixes the light condenser to the frame from a light entering side or a light emission side of the light.

The present invention provides an image reading apparatus including: the image sensor unit; and a movement portion that relatively moves the image sensor unit and the illuminated object.

The present invention provides an image forming apparatus including: the image sensor unit; a movement portion that relatively moves the image sensor unit and the illuminated object; and an image forming portion that forms, in a recording medium, an image read by the image sensor unit.

### Advantageous Effects of Invention

According to the present invention, the light condenser can be easily assembled to the frame.

### BRIEF DESCRIPTION OF DRAWINGS

FIG. 1 is a sectional view of an image sensor unit 1A.

FIG. 2 is a perspective view illustrating an appearance of an MFP 100 including the image sensor unit 1A.

FIG. 3 is a schematic view illustrating a structure of an image forming portion 113 of the MFP 100.

FIG. 4 is a perspective view of the image sensor unit 1A.

FIG. 5 is an exploded perspective view of the image sensor unit 1A.

FIG. 6 is an exploded perspective view illustrating part of the image sensor unit 1A.

FIG. 7 is a perspective view of the image sensor unit 1A cut in a sub-scan direction.

FIG. 8 is a perspective view of the image sensor unit 1A cut in a main-scan direction.

FIG. 9 is a perspective view of the image sensor unit 1A cut in the main-scan direction.

FIG. 10 is an exploded perspective view of an image sensor unit 1B.

FIG. 11 is a perspective view of the image sensor unit 1B cut in the sub-scan direction.

FIG. 12 is an exploded perspective view of an image sensor unit 1C.

FIG. 13 is a perspective view before a holding portion 60C is fitted to a fitting groove portion 26.

FIG. 14 is a perspective view after the holding portion 60C is fitted to the fitting groove portion 26.

FIG. 15 is an exploded perspective view of an image sensor unit 1D.

FIG. 16 is a perspective view illustrating part of an urging member 50D.

FIG. 17 is a perspective view before a holding portion 60D is fitted to the fitting groove portion 26.

FIG. 18A is a perspective after the holding portion 60D is fitted to the fitting groove portion 26.

FIG. 18B is a perspective view after the holding portion 60D is fitted to the fitting groove portion 26.

FIG. 19 is a perspective view of an image sensor unit 1E.

FIG. 20 is an exploded perspective view of the image sensor unit 1E.

FIG. 21 is a perspective view of the image sensor unit 1E cut in the sub-scan direction.

FIG. 22 is a perspective view of the image sensor unit 1E cut in the main-scan direction.

FIG. 23 is an exploded perspective view of an image sensor unit 1F.

FIG. 24 is a perspective view of an urging member 50F.

FIG. 25 is a perspective view of a holding member 80F.

FIG. 26 is a sectional view of the image sensor unit 1F cut in the sub-scan direction.

FIG. 27 is a perspective view of the image sensor unit 1F from below.

FIG. 28 is a perspective view of an urging member 50G.

FIG. 29A is a perspective view of a holding member 80G.

FIG. 29B is a perspective view of the holding member 80G.

FIG. 30 is a sectional view of an image sensor unit 1G cut in the sub-scan direction.

FIG. 31 is a perspective view of an urging member 50H.

### DESCRIPTION OF EMBODIMENTS

Embodiments of the present invention will now be described in detail with reference to the drawings. The present embodiments provide an image sensor unit 1A as well as an image reading apparatus and an image forming apparatus to which the image sensor unit 1A is applied. In the image reading apparatus and the image forming apparatus, the image sensor unit 1A emits light to an original P as an illuminated object, and reflected light is converted to an electric signal to read an image.

In the following description, three-dimensional directions will be indicated by X, Y, and Z arrows. The X direction denotes a main-scan direction, the Y direction denotes a sub-scan direction perpendicular to the main-scan direction, and the Z direction denotes a perpendicular direction (vertical direction).

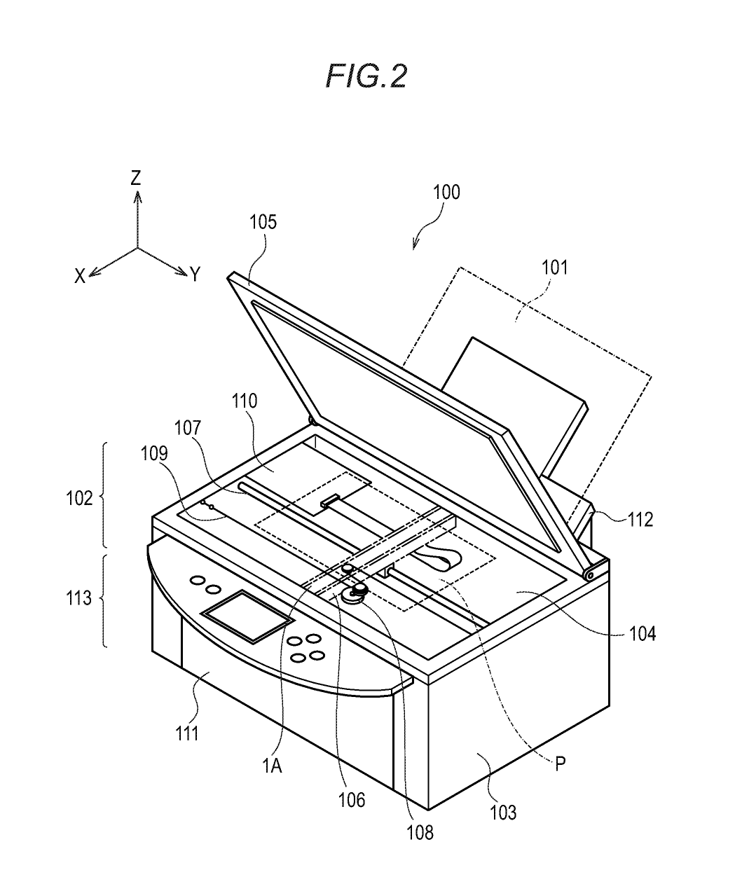

A structure of a multi-function printer (MFP) as an example of the image reading apparatus or the image forming apparatus according to the present embodiments will be described with reference to FIG. 2. FIG. 2 is a perspective view illustrating an appearance of an MFP 100. As illustrated in FIG. 2, the MFP 100 includes: an image reading portion 102 as image reading means for reading reflected light from the original P; and an image forming portion 113 as image forming means for forming (printing) an image of the original P on a sheet 101 (recording paper) as a recording medium.

The image reading portion 102 has a function of a so-called image scanner and is configured, for example, as follows. The image reading portion 102 includes: a housing 103; a platen glass 104 as an original placing portion made of a glass transparent plate; and a platen cover 105 that can be freely opened and closed relative to the housing 103 so as to be able to cover the original P.

The housing 103 houses the image sensor unit 1A including an illumination apparatus, a holding member 106, a slide shaft 107, a drive motor 108, a wire 109, a signal processing portion 110, a recovery unit 111, a paper feeding tray 112, and the like.

The image sensor unit 1A is, for example, a contact image sensor (CIS) unit. The holding member 106 surrounds and holds the image sensor unit 1A. The slide shaft 107 guides the holding member 106 in the sub-scan direction along the platen glass 104. The drive motor 108 is a movement portion that relatively moves the image sensor unit 1A and the original P, and specifically, the drive motor 108 moves the wire 109 attached to the holding member 106. The recovery unit 111 can be freely opened and closed relative to the housing 103 and is configured to recover the printed sheet 101. The paper feeding tray 112 houses the sheet 101 in a predetermined size.

In the image reading portion 102 with the configuration described above, the drive motor 108 moves the image sensor unit 1A in the sub-scan direction along the slide shaft 107. In this case, the image sensor unit 1A optically reads the original P placed on the platen glass 104 to convert the light to an electric signal to perform reading operation of the image.

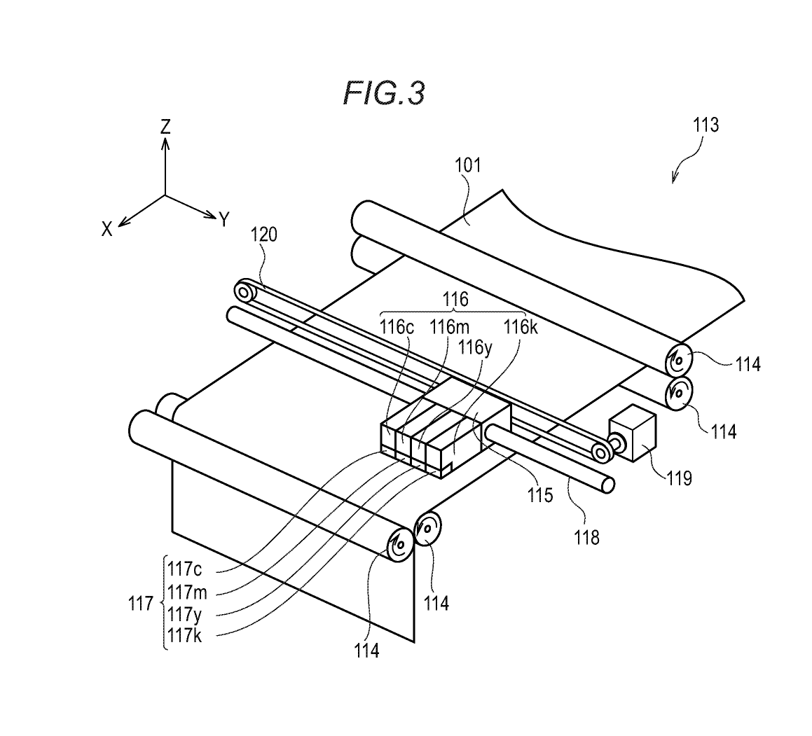

FIG. 3 is a schematic view illustrating a structure of the image forming portion 113.

The image forming portion 113 has a function of a so-called printer and is configured, for example, as follows. The image forming portion 113 is housed in the housing 103 and includes conveyance rollers 114 and a recording head 115 as illustrated in FIG. 3. The recording head 115 includes, for example: ink tanks 116 (116c, 116m, 116y, and 116k) with cyan C, magenta M, yellow Y, and black K inks; and discharge heads 117 (117c, 117m, 117y, and 117k) provided to the ink tanks 116, respectively. The image forming portion 113 includes a recording head slide shaft 118, a recording head drive motor 119, and a belt 120 attached to the recording head 115.

In the image forming portion 113 with the configuration described above, the conveyance rollers 114 convey the sheet 101 supplied from the paper feeding tray 112 to the recording position. The recording head drive motor 119 mechanically moves the belt 120, and the recording head 115 performs printing on the sheet 101 based on an electric signal while moving in a printing direction (main-scan direction) along the recording head slide shaft 118. The operation is repeated until the printing is finished, and the conveyance rollers 114 eject the printed sheet 101 to the recovery unit 111.

Although the inkjet-type image forming apparatus has been described as the image forming portion 113, the type can be any type, such as an electrophotographic type, a thermal transfer type, and a dot impact type.

### First Embodiment

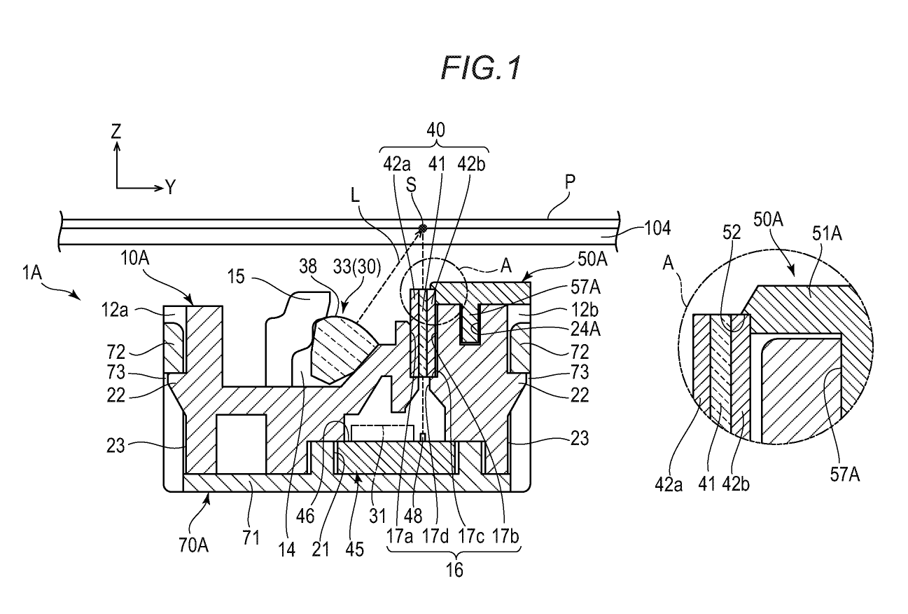

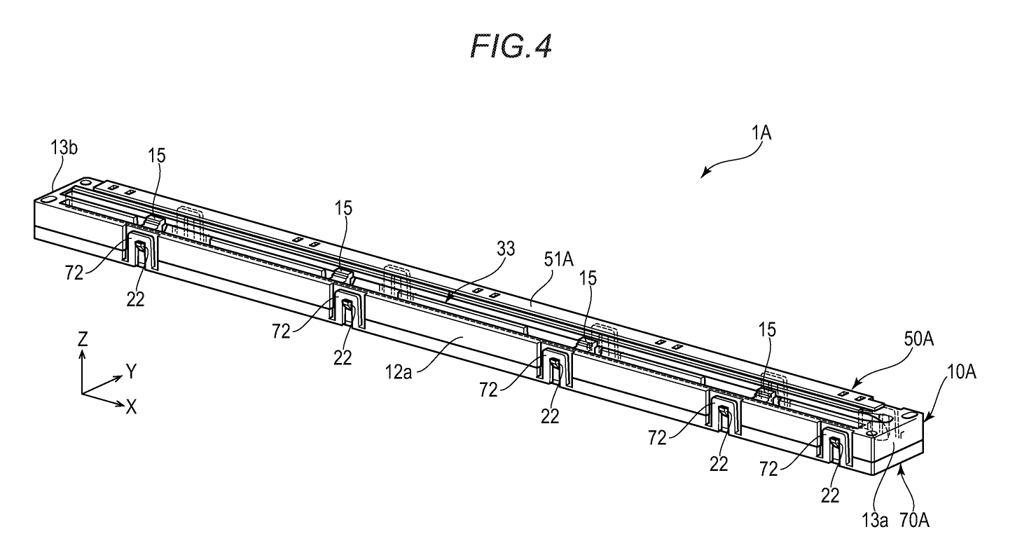

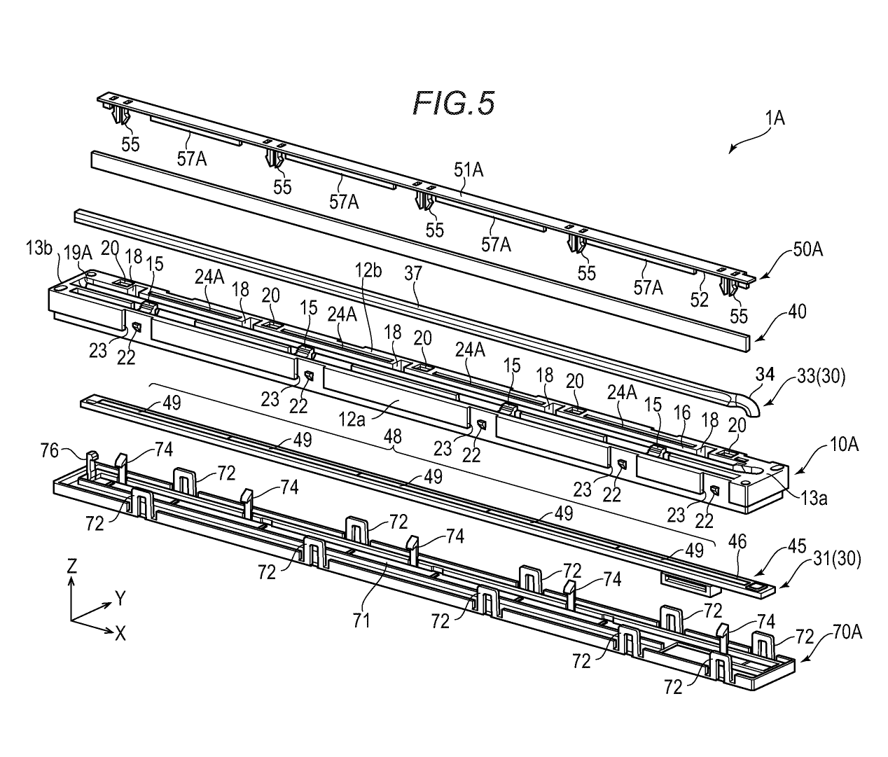

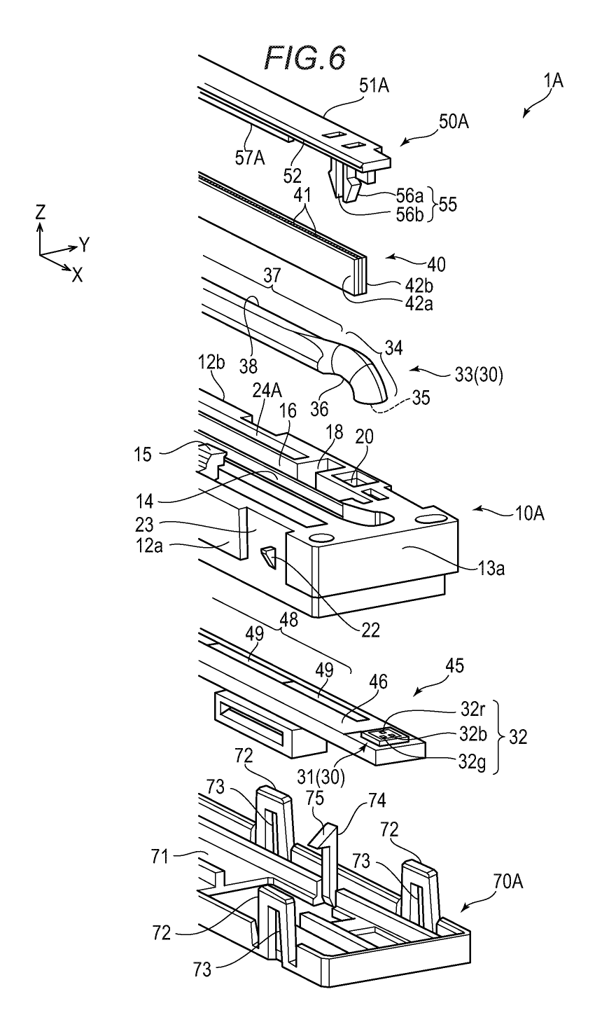

A configuration of the image sensor unit 1A of a first embodiment will be described with reference to the drawings. FIG. 1 is a sectional view of the image sensor unit 1A cut in the sub-scan direction. FIG. 4 is an external perspective view of the image sensor unit 1A. FIG. 5 is an exploded perspective view of the image sensor unit 1A. FIG. 6 is an exploded perspective view illustrating part of the image sensor unit 1A.

The image sensor unit 1A includes a frame 10A, an illumination portion 30, a light condenser 40, a sensor substrate 45, an image sensor 48, an urging member 50A as a stopper, a cover member 70A, and the like. The illumination portion 30 can be caused to function as an illumination apparatus. Among the constituent members described above, the frame 10A, the illumination portion 30, the light condenser 40, the sensor substrate 45, the image sensor 48, the urging member 50A, and the cover member 70A have lengths according to the dimension in the main-scan direction of the original P to be read.

The frame 10A is a housing member that houses the constituent members of the image sensor unit 1A. An outer wall portion 12a on one side in the sub-scan direction, an outer wall portion 12b on the other side in the sub-scan direction, a side wall portion 13a on one side in the main-scan direction, and a side wall portion 13b on the other side in the main-scan direction form the outer shape of the frame 10A in a substantially rectangular solid shape with the main-scan direction as a longitudinal direction. The inside of the frame 10A is formed to be able to position and support the constituent members.

As illustrated in FIG. 1, a light guide housing portion 14 that houses a light guide 33 described later of the illumination portion 30 is formed in the main-scan direction at substantially the center on the upper side of the frame 10A. A plurality of (for example, four) locking pieces 15 for engaging the light guide 33 are formed on the light guide housing portion 14 at intervals in the main-scan direction. The locking pieces 15 are elastically deformed, and the light guide 33 is detachably engaged.

A light condenser housing portion 16 that houses the light condenser 40 is formed in the main-scan direction at a position adjacent to the light guide housing portion 14 of the frame 10A. As illustrated in FIG. 1, the light condenser housing portion 16 is formed in a groove shape by an inner wall portion 17a on one side in the main-scan direction, an inner wall portion 17b on the other side in the main-scan direction, and a bottom part 17c. The wall surfaces of the inner wall portion 17a and the inner wall portion 17b are parallel and face each other, and have a gap that allows housing the light condenser 40. A passage hole 17d for passing the light emitted from the light condenser 40 toward the image sensor 48 is formed on the bottom part 17c in the main-scan direction. As illustrated in FIG. 5, both ends of the light condenser housing portion 16 in the main-scan direction are blocked by the side wall portions 13a and 13b.

Vertically opened insertion holes 18 for inserting second abutment portions 74 described later of the cover member 70A are formed at positions close to the light condenser housing portion 16 of the frame 10A. As illustrated in FIG. 5, a plurality of (for example, five) insertion holes 18 are formed at intervals in the main-scan direction. The inner wall portion 17b is not formed on part of the positions adjacent to the insertion holes 18 in the light condenser housing portion 16, and the light condenser housing portion 16 and the insertion holes 18 communicate with each other.

A vertically opened insertion hole 19A for inserting a third abutment portion 76 described later of the cover member 70A is formed at a position close to the light condenser housing portion 16 of the frame 10A and the side wall portion 13b on the other side. As illustrated in FIG. 5, a single insertion hole 19A is formed, and the insertion hole 19A communicates with the light condenser housing portion 16.

Engaged portions 20 engaged with engagement portions 55 described later of the urging member 50A are formed in a concave shape from the upper side of the frame 10A, at positions close to the light condenser housing portion 16 of the frame 10A. As illustrated in FIG. 5, a plurality of (for example, five) engaged portions 20 are formed at intervals in the main-scan direction.

As illustrated in FIG. 1, a substrate housing portion 21 that houses the sensor substrate 45 is formed on the lower side of the frame 10A throughout the main-scan direction.

Held portions 22 engaged with holding portions 72 described later of the cover member 70A protrude and are formed on the outer wall portions 12a and 12b of the frame 10A. The held portions 22 are formed in a substantially triangular shape. As illustrated in FIG. 5, a plurality of (for example, five) held portions 22 are formed on the outer wall portions 12a on one side, at intervals in the main-scan direction. Similarly, the held portions 22 are formed on the outer wall portion 12b on the other side. Fitting groove portions 23 with part of the wall surfaces recessed toward the inside of the frame 10A are formed on the outer wall portion 12a on one side and the outer wall portion 12b on the other side of the frame 10A, at intervals in the main-scan direction. The held portion 22 is positioned in each fitting groove portion 23.

The frame 10A is formed by, for example, a light-blocking resin material colored in black. The resin material can be, for example, polycarbonate.

The illumination portion 30 linearly illuminates the original P. The illumination portion 30 of the present embodiment includes a light source 31 and the light guide 33.

The light source 31 emits light to illuminate the original P through the light guide 33. As illustrated in FIG. 6, the light source 31 can be a so-called top-view surface-mount LED package in which LED chips 32 as light emitting elements are mounted on the surface. The light source 31 is mounted on a mounting surface 46 on one side of the sensor substrate 45 in the longitudinal direction and emits light upward. The light source 31 is provided with a plurality of (for example, three) LED chips 32r, 32g, and 32b sealed by a transparent resin. The LED chips 32r, 32g, and 32b emit visible light with red, green, and blue (hereinafter, also called RGB) emission wavelengths, respectively. The LED chips may emit, instead of the visible light, light with emission wavelengths of infrared light or ultraviolet light in order to read an image printed on the original P using invisible ink.

The light guide 33 linearly emits the light emitted from the light source 31 toward the original P. In the light guide 33, a curved portion 34 curved on one side and a rod-shaped linear portion 37 extending toward the other side with the main-scan direction as a longitudinal direction are integrally formed.

The curved portion 34 guides the light from the light source 31 to the linear portion 37. As illustrated in FIG. 6, an incident surface 35 that receives the light from the light source 31 is formed on an end surface of the curved portion 34. The incident surface 35 is substantially parallel to the light source 31 and faces the light source 31 at a slight interval such that the light from the light source 31 is incident on the light guide 33 at a good yield. A reflection surface 36 that reflects the light entered from the incident surface 35 toward the linear portion 37 is formed on the peripheral surface of the curved portion 34.

The linear portion 37 linearly emits the light guided from the curved portion 34 toward the original P. An emission surface 38 that emits the light guided from the curved portion 34 toward the original P is formed on the surface of the linear portion 37 opposing the original P. As illustrated in FIG. 1, the emission surface 38 is formed in, for example, an arc shape that is convex upward in order to condense the light on a reading line S of the original P. The surfaces of the linear portion 37 other than the emission surface 38 function as reflection surfaces that propagate the light guided from the curved portion 34 to the other side of the linear portion 37 or that reflect the light toward the emission surface 38.

The light guide 33 is formed by, for example, an acrylic transparent resin material.

The light condenser 40 condenses the light including image information from the original P and forms an image on the image sensor 48. Here, the upper surface of the light condenser 40 is a light entering surface that imports the light, and the lower surface thereof is a light emission surface that emits the imported light. The light condenser 40 is formed with the main-scan direction as a longitudinal direction and can be, for example, a rod lens array. As illustrated in FIG. 6, a plurality of rod lens 41 as image forming elements of an erect equal magnification imaging type are arranged such that the optical axes are parallel, and a plate member 42a from one side in the sub-scan direction and a plate member 42b from the other side sandwich and couple the rod lenses 41 in the light condenser 40. The rod lenses 41 are formed by, for example, glass or a transparent resin material. The plate member 42a and the plate member 42b are formed by, for example, a glass epoxy resin and function as binder portions that hold the rod lenses 41. In the light condenser 40, the plurality of rod lenses 41 are coupled by filling a black silicone resin between the plate member 42a and the plate member 42b to remove flare light.

The light condenser 40 is inserted into the light condenser housing portion 16 of the frame 10A from the upper side and is housed in the light condenser housing portion 16. The light condenser 40 is not limited to the configuration described above as long as an image can be formed on the image sensor 48. The light condenser 40 can be an optical member with various conventionally well-known light condensing functions, such as various micro-lens arrays.

In the sensor substrate 45, the light source 31, a driver circuit that causes the light source 31 to emit light or drives the image sensor 48, and the like are mounted on the mounting surface 46. The sensor substrate 45 is formed in a planar shape with the main-scan direction as a longitudinal direction.

The image sensor 48 receives the light formed by the light condenser 40 and converts the light to an electric signal. The image sensor 48 is arranged on the lower side of the light condenser 40. As illustrated in FIG. 5, a predetermined number of image sensor ICs 49 including a plurality of light receiving elements (the light receiving elements may be called photoelectric conversion elements) according to the resolution of reading of the image sensor unit 1A are linearly arranged in the main-scan direction on the mounting surface 46 of the sensor substrate 45 and mounted on the image sensor 48. The image sensor 48 is not limited to the configuration described above as long as the light reflected from the original P can be converted to an electric signal. The image sensor ICs 49 can be various conventionally well-known image sensor ICs.

The urging member 50A is mounted on the frame 10A to urge and fix the light condenser 40 to the frame 10A. The urging member 50A urges the light condenser 40, and the light condenser 40 is held without being separated from the inside of the light condenser housing portion 16. The urging member 50A is formed by, for example, a resin material with the main-scan direction as a longitudinal direction.

The urging member 50A includes a body portion 51A as a flange portion, the engagement portions 55, and positioning pieces 57A.

The body portion 51A has a planar shape in the main-scan direction and has substantially the same length as the length of the light condenser 40 in the main-scan direction. In the body portion 51A, a first abutment portion 52 that abuts with the light condenser 40 in the main-scan direction is formed at an end on one side in the sub-scan direction. As illustrated in an enlarged view of A in FIG. 1, the first abutment portion 52 is cut out to be able to correspond to and abut with the corner of the plate member 42b in the light condenser 40. The engagement portions 55 and the positioning pieces 57A are integrally formed on the lower surface of the body portion 51A.

The engagement portions 55 engage with the engaged portions 20 of the frame 10A. A plurality of (for example, five) engagement portions 55 are formed at intervals in the main-scan direction. As illustrated in FIG. 6, the engagement portions 55 are formed in a bifurcated shape by a pair of engagement pieces 56a and 56b facing downward from the lower surface of the body portion 51A. The tips of the pair of engagement pieces 56a and 56b are tapered, and the centers are expanded. The pair of engagement pieces 56a and 56b are elastically deformed in directions approaching each other when external force is applied, and the pair of engagement pieces 56a and 56b return to the original state away from each other when the external force is no longer applied.

The positioning pieces 57A are inserted into positioning holes 24A of the frame 10A. A plurality of (for example, four) positioning pieces 57A are formed at intervals in the main-scan direction. The positioning pieces 57 are formed in a planar shape with the main-scan direction as a longitudinal direction, at positions adjacent to the engagement portions 55.

The cover member 70A is mounted on the frame 10A to hold the sensor substrate 45 housed in the substrate housing portion 21. The cover member 70A is formed by, for example, a resin material with the main-scan direction as a longitudinal direction.

The cover member 70A includes a body portion 71, the holding portions 72, the second abutment portions 74, and the third abutment portion 76.

The body portion 71 has a planar shape in the main-scan direction and has substantially the same size as the size of the lower surface of the frame 10A. In the body portion 71, the holding portions 72 are integrally formed from the ends on both sides in the sub-scan direction. In the body portion 71, the second abutment portions 74 are integrally formed from the upper surface on the other side in the sub-scan direction. In the body portion 71, the third abutment portion 76 is integrally formed from the upper surface on the other side in the main-scan direction.

The holding portions 72 engage with the held portions 22 of the frame 10A. A plurality of (for example, ten) holding portions 72 are formed at intervals in the main-scan direction, on both sides in the sub-scan direction. As illustrated in FIG. 6, planar holding holes 73 engaged with the held portions 22 at the center are formed on the holding portions 72. The holding portions 72 are formed to protrude upward from the body portion 71. The holding portions 72 are elastically deformed in the sub-scan direction when external force is applied, and the holding portions 72 return to the original state when the external force is no longer applied.

As the cover member 70A is mounted on the frame 10A, the second abutment portions 74 abut with the outer surface of the plate member 42b of the light condenser 40. A plurality of (for example, five) second abutment portions 74 are formed at intervals in the main-scan direction. The second abutment portions 74 are formed to protrude upward from the body portion 71 and are elastically deformed in the sub-scan direction. As illustrated in FIG. 6, an inclined portion 75 is formed on the upper surface of the tip portion of the second abutment portion 74, and one side of the tip portion in the sub-scan direction is tapered.

As the cover member 70A is mounted on the frame 10A, the third abutment portion 76 abuts with the end surface on the other side of the light condenser 40 in the main-scan direction. A single third abutment portion 76 is formed on the other side in the main-scan direction. The third abutment portion 76 is formed to protrude upward from the body portion 71 and is elastically deformed in the main-scan direction. As illustrated in FIG. 8 described later, an inclined portion 77 is formed on part of the upper surface of the tip portion of the third abutment portion 76, and one side of the tip portion in the main-scan direction is tapered.

Next, assembly of the image sensor unit 1A will be described.

First, the light source 31, the image sensor 48, the drive circuit, and the like are mounted on predetermined positions of the sensor substrate 45.

Next, the sensor substrate 45 is arranged at a predetermined position of the body portion 71 of the cover member 70A, and the cover member 70A is mounted on the frame 10A. Specifically, the cover member 70A and the frame 10A are brought closer to fit the holding portions 72 of the cover member 70A into the fitting groove portions 23 of the frame 10A. In this case, the holding portions 72 collide with the held portions 22, and the holding portions 72 are elastically deformed to extend in the sub-scan direction. The holding portions 72 climb over the held portions 22, and the holding portions 72 return to the original state. The held portions 22 are inserted into the holding holes 73 in the holding portions 72, and the cover member 70A is mounted on the frame 10A.

As the cover member 70A is mounted on the frame 10A, the cover member 70A holds the sensor substrate 45 housed in the substrate housing portion 21. The second abutment portions 74 are inserted into the insertion holes 18, and the third abutment portion 76 is inserted into the insertion hole 19A. One side in the sub-scan direction of the tip portion of the second abutment portion 74 is positioned in the light condenser housing portion 16. One side in the main-scan direction of the tip portion of the third abutment portion 76 is positioned in the light condenser housing portion 16.

Next, the light guide 33 is housed in the light guide housing portion 14 of the frame 10A. Specifically, the light guide 33 is pressed toward the light guide housing portion 14 from above, and the locking pieces 15 are elastically deformed in the direction in which the opening of the light guide housing portion 14 expands. As the light guide 33 is inserted into the light guide housing portion 14, the locking pieces 15 return to the original state to engage the light guide 33. In this state, the incident surface 35 of the curved portion 34 of the light guide 33 and the light source 31 face each other.

Next, the light condenser 40 is housed in the light condenser housing portion 16 of the frame 10A. Specifically, the light condenser 40 is inserted into the light condenser housing portion 16 from above. Although part of the second abutment portions 74 and part of the third abutment portion 76 are positioned in the light condenser housing portion 16 here, the inclined portions 75 and the inclined portion 77 are formed on the upper surfaces of the second abutment portions 74 and the upper surface of the third abutment portion 76, respectively. Therefore, when the light condenser 40 is inserted, the light condenser 40 comes into contact with the inclined portions 75 of the second abutment portions 74, and the second abutment portions 74 are elastically deformed toward the other side in the sub-scan direction. On the other hand, the light condenser 40 comes into contact with the inclined portion 77 of the third abutment portion 76, and the third abutment portion 76 is elastically deformed toward the other side in the main-scan direction. Therefore, the insertion of the light condenser 40 into the light condenser housing portion 16 is not prevented.

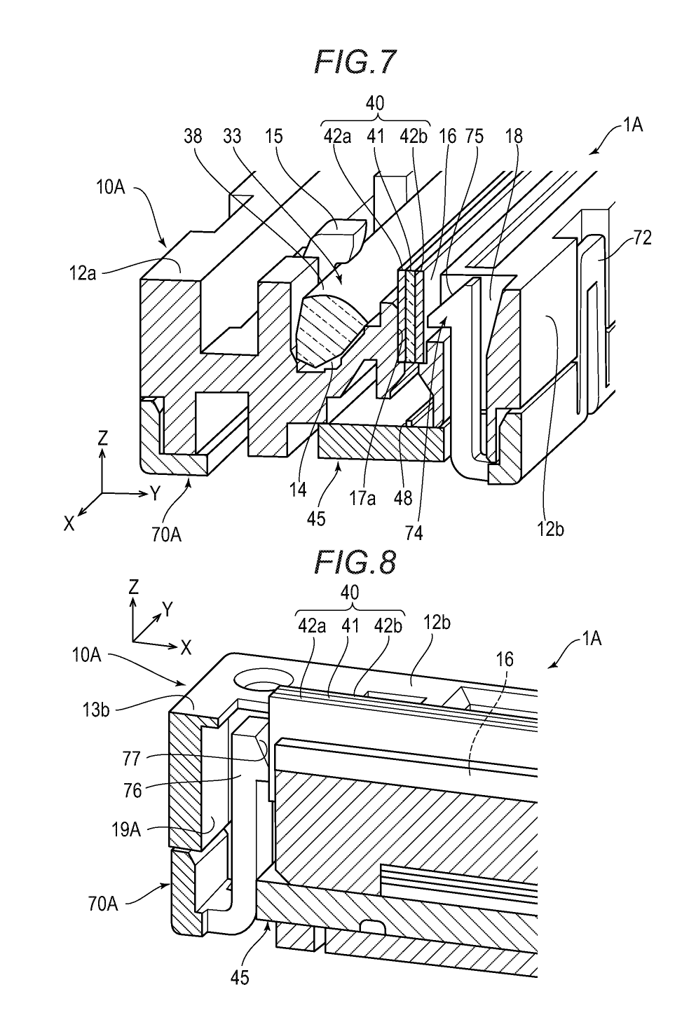

FIG. 7 is a sectional view cut in the sub-scan direction of the light condenser 40 housed in the light condenser housing portion 16. As illustrated in FIG. 7, the second abutment portion 74 abuts with the outer surface of the plate member 42b of the light condenser 40 and urges the light condenser 40 toward the inner wall portion 17a of the light condenser housing portion 16. Therefore, the light condenser 40 is pressed against the inner wall portion 17a and housed in the light condenser housing portion 16.

FIG. 8 is a sectional view cut in the main-scan direction of the light condenser 40 housed in the light condenser housing portion 16. As illustrated in FIG. 8, the third abutment portion 76 abuts with the end surface on the other side of the light condenser 40 and urges the light condenser 40 toward the side wall portion 13a of the frame 10A. Therefore, the light condenser 40 is pressed against the side wall portion 13a and housed in the light condenser housing portion 16.

Next, the engagement portions 55 of the urging member 50A are engaged with the engaged portions 20 of the frame 10A to mount the urging member 50A on the frame 10A. Specifically, the urging member 50A is pressed into the frame 10A, and the external force from the holes of the engaged portions 20 elastically deforms the pairs of engagement pieces 56a and 56b of the engagement portions 55 in directions in which the pairs of engagement pieces 56a and 56b approach each other.

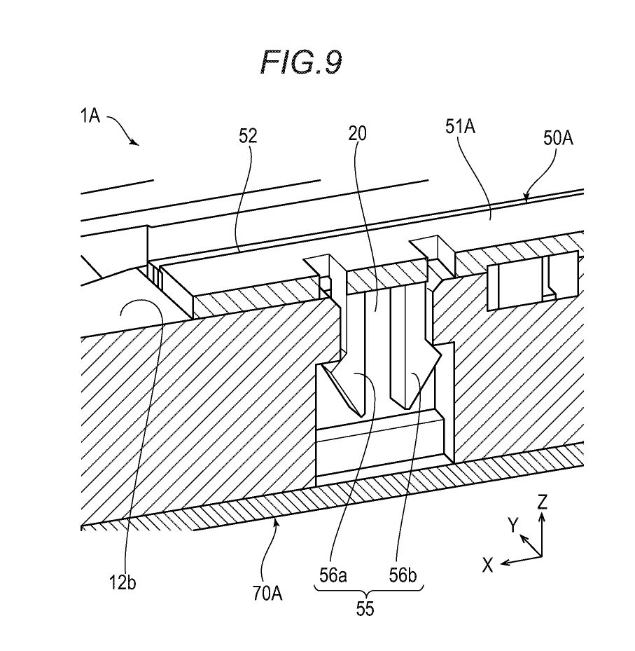

FIG. 9 is a sectional view cut in the main-scan direction of the urging member 50A mounted on the frame 10A. As illustrated in FIG. 9, the pair of engagement pieces 56a and 56b reach a wide space of the engaged portion 20, and the pair of engagement pieces 56a and 56b return to the original state to engage with the engaged portion 20.

In this case, the positioning pieces 57A of the urging member 50A are inserted into the positioning holes 24A, and the urging member 50A is accurately positioned in the main-scan direction and the sub-scan direction of the frame 10A.

As illustrated in FIG. 1, the first abutment portion 52 abuts with the light entering surface side of the light condenser 40. Specifically, the first abutment portion 52 avoids the rod lenses 41 of the light condenser 40 and abuts with the light condenser 40 so as to cover the upper surface of the plate member 42b. Here, the first abutment portion 52 abuts with the light condenser 40 at a position intersecting with the direction in which the light condenser 40 separates from the light condenser housing portion 16. Therefore, the first abutment portion 52 holds the light condenser 40 housed in the light condenser housing portion 16. The first abutment portion 52 avoids the rod lenses 41 and abuts with the light condenser 40, and this prevents obstructing the optical path of the light condenser 40.

When the engagement pieces 56a and 56b and the engaged portions 20 are engaged, the engagement pieces 56a and 56b are pulled toward the engaged portions 20, and the own body portion 51A of the urging member 50A is urged downward. Therefore, the first abutment portion 52 of the body portion 51A urges the light condenser 40 toward the bottom part 17c of the frame 10A. Therefore, the light condenser 40 is pressed against the bottom part 17c of the light condenser housing portion 16 and housed in the light condenser housing portion 16.

In this case, in the bottom part 17c, the first abutment portion 52 avoids the rod lenses 41 of the light condenser 40 and abuts with the lower surface of the plate member 42a and the lower surface of the plate member 42b.

Next, removal of the constituent members of the image sensor unit 1A from the frame 10A will be described.

The cover member 70A is separated from the frame 10A to remove the sensor substrate 45 from the substrate housing portion 21 of the frame 10A. Specifically, the holding portions 72 of the cover member 70A are elastically deformed and extended in the sub-scan direction to release the engagement with the held portions 22 of the frame 10A. The cover member 70A is separated from the frame 10A while the engagement of the holding portions 72 and the held portions 22 are released. Therefore, the cover member 70A holding the sensor substrate 45 can be separated to remove the sensor substrate 45 from the substrate housing portion 21. In this way, the sensor substrate 45 can be attached to and removed from the frame 10A through the cover member 70A that can be attached to and detached from the frame 10A.

The locking pieces 15 are elastically deformed to extend the opening of the light guide housing portion 14 to remove the light guide 33 from the light guide housing portion 14 of the frame 10A. In this way, the light guide 33 can be easily attached to and detached from the frame 10A.

The urging member 50A is separated from the frame 10A to remove the light condenser 40 from the light condenser housing portion 16 of the frame 10A. Specifically, the urging member 50A is pulled away in a direction opposite the direction in which the urging member 50A is mounted on the frame 10A, and the external force from the engaged portions 20 elastically deforms the pairs of engagement pieces 56a and 56b of the engagement portions 55 in directions in which the pairs of engagement pieces 56a and 56b approach each other. The pairs of the engagement pieces 56a and 56b are pulled out of the holes of the engaged portions 20 to separate the urging member 50A from the frame 10A. Therefore, the urging member 50A holding the light condenser 40 can be separated to remove the light condenser 40 from the light condenser housing portion 16. In this way, the light condenser 40 can be attached to and removed from the frame 10A through the urging member 50A that can be attached to and detached from the frame 10A.

Operation of the image sensor unit 1A with the configuration will described above be described.

The image sensor unit 1A causes the LED chips 32 of the light source 31 to sequentially emit light. As illustrated in FIG. 1, the light guide 33 emits the light from the light source 31 to the lower surface of the original P as indicated by an arrow L. Therefore, the light is linearly emitted to the original P throughout the reading line S (main-scan direction). The light emitted from the light guide 33 is reflected by the original P, and the reflected light is focused on the image sensor 48 through the light condenser 40. The image sensor 48 can convert the focused light to an electric signal to read the image on the lower surface of the original P.

The image sensor 48 reads the light from the original P for one scan line to complete the reading operation of one scan line of the original P in the main-scan direction. After the reading operation of one scan line is finished, the reading operation of next one scan line is performed in the same way as the operation described above along with relatively movement of the original P in the sub-scan direction. In this way, the image sensor unit 1A repeats the reading operation of one scan line while moving in the sub-scan direction to sequentially scan the entire surface of the original P to read the image.

The image sensor unit 1A of the present embodiment includes the urging member 50A that urges and fixes the light condenser 40 to the frame 10A, and the urging member 50A urges and fixes the light condenser 40 to the frame 10A from the light entering side of the light. Therefore, the light condenser 40 can be easily assembled to the frame 10A without using an adhesive. In this case, the urging member 50A urges the light condenser 40 to the frame 10A, and the light condenser 40 is accurately positioned in the light condenser housing portion 16. Since the adhesive does not have to be used, the adhesive is not attached to the rod lenses 41 of the light condenser 40, and the generation of stray light caused by the adhesive can be prevented. Since the adhesive does not have to be used, an automatic assembly machine can be used to easily assemble the image sensor unit 1A.

Although the urging member 50A urges and fixes the light condenser 40 to the frame 10A from the light entering side of the light in the description of the present embodiment, the arrangement is not limited to this. For example, if the light condenser 40 is inserted into the light condenser housing portion 16 of the frame 10A from below and housed in the light condenser housing portion 16, the urging member 50A can urge and fix the light condenser 40 to the frame 10A from the light emission side of the light.

An adhesive may also be used in the present embodiment to assemble the light condenser 40 to the frame 10A. When the adhesive is also used, there is an advantageous effect that the amount of adhesive can be reduced.

The urging member 50A urges and fixes the light condenser 40 to the frame 10A at a position that does not obstruct the optical path of the light condenser 40. Therefore, the light condenser 40 can focus the light reflected by the original P on the image sensor 48 without being interfered by the urging member 50A.

The urging member 50A includes the engagement portions 55, and the frame 10A includes the engaged portions 20 engaged with the engagement portions 55. The urging member 50A is detachably engaged with the frame 10A. Therefore, the urging member 50A can be attached to the frame 10A in a so-called snap-fit format.

The second abutment portions 74 of the cover member 70A urge the light condenser 40 in a direction orthogonal to both the longitudinal direction of the light condenser 40 and the optical axis direction of the light condenser 40, more specifically, toward the inner wall portion 17a of the light condenser housing portion 16. Therefore, the light condenser 40 can be accurately positioned in the light condenser housing portion 16. The second abutment portions 74 may urge the light condenser 40 toward the inner wall portion 17b, instead of the inner wall portion 17a.

The third abutment portion 76 of the cover member 70A urges the light condenser 40 in the longitudinal direction of the light condenser 40, specifically, toward the side wall portion 13a of the frame 10A. Therefore, the light condenser 40 can be accurately positioned in the light condenser housing portion 16. The third abutment portion 76 may be urged toward the side wall portion 13b, instead of the side wall portion 13a.

When the light condenser 40 is viewed in the direction orthogonal to the light entering surface, the side surface of the light condenser 40 that is the longitudinal direction is urged to the frame 10A and supported by the frame 10A. The urging member 50A mounted on the frame 10A in a snap-fit format includes the first abutment portion 52 as a flange portion, and the first abutment portion 52 abuts with the light entering surface side of the light condenser 40. Therefore, the light condenser 40 can be easily assembled to the frame 10A, and the light condenser 40 can be accurately positioned on the frame 10A.

### Second Embodiment

A configuration of an image sensor unit 1B of a second embodiment will be described with reference to the drawings. Although the cover member 70A includes the second abutment portions 74 in the first embodiment, an urging member 50B includes second abutment portions 58B in the case described in the second embodiment. The same reference signs are provided to the same components as in the first embodiment, and the description of the same component will not be repeated.

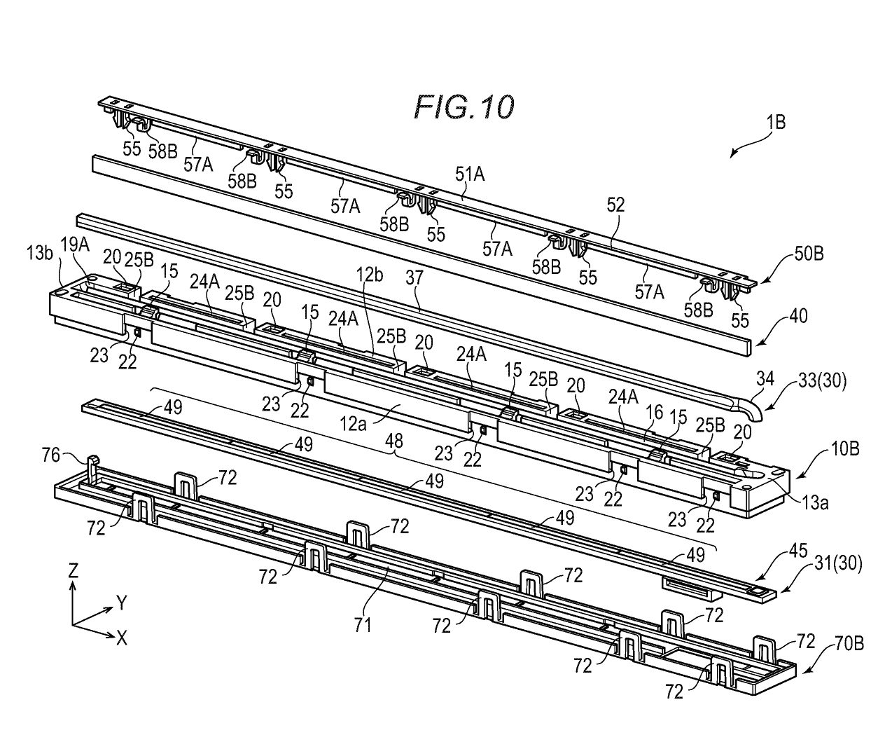

FIG. 10 is an exploded perspective view of the image sensor unit 1B.

The image sensor unit 1B of the present embodiment includes a frame 10B, the illumination portion 30, the light condenser 40, the sensor substrate 45, the image sensor 48, the urging member 50B, a cover member 70B, and the like.

In the urging member 50B, the second abutment portions 58B are integrally formed on the lower surface of the body portion 51A. As the urging member 50B is mounted on the frame 10B, the second abutment portions 58B abut with an outer surface of the plate member 42b of the light condenser 40, the outer surface facing the inner wall portion 17b of the light condenser housing portion 16. A plurality of (for example, five) second abutment portions 58B are formed at intervals in the main-scan direction. The second abutment portions 58B protrude downward from the body portion 51A and then extend in the sub-scan direction.

In the frame 10B, insertion holes 25B for inserting the second abutment portions 58B of the urging member 50B are formed at positions close to the light condenser housing portion 16. A plurality of (for example, five) insertion holes 25B are formed at intervals in the main-scan direction. The inner wall portion 17b is not formed on part of the positions adjacent to the insertion holes 25B in the light condenser housing portion 16, and the light condenser housing portion 16 and the insertion holes 25B communicate with each other.

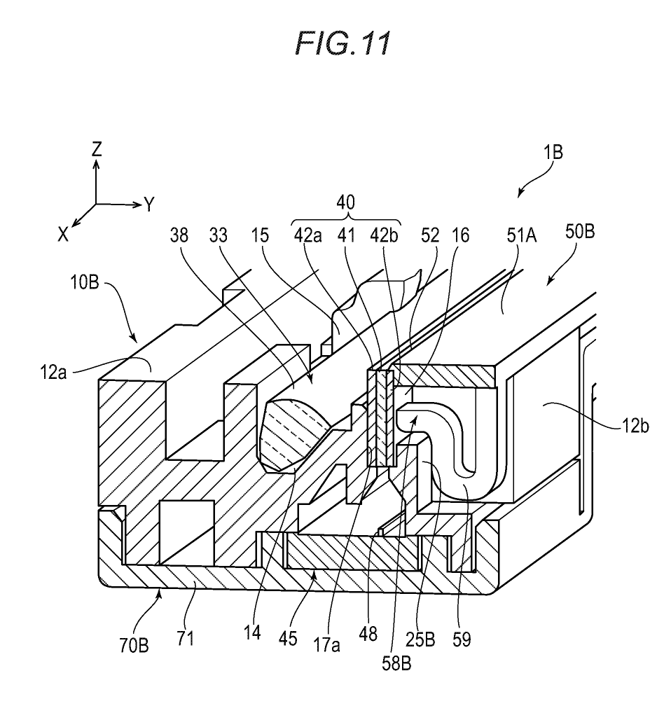

FIG. 11 is a sectional view cut in the sub-scan direction of the urging member 50B mounted on the frame 10B. As illustrated in FIG. 11, the tip of the second abutment portion 58 abuts with the outer surface of the plate member 42b of the light condenser 40 through a flexible portion 59 curved and folded back, and the second abutment portion 58B urges the light condenser 40 toward the inner wall portion 17a of the light condenser housing portion 16. Therefore, the light condenser 40 is pressed against the inner wall portion 17a and housed in the light condenser housing portion 16.

In this way, according to the image sensor unit 1B of the present embodiment, the second abutment portions 58B are formed on the urging member 50B, and the light condenser 40 is urged to the frame 10B from one side in the lateral direction orthogonal to both the optical axis direction and the longitudinal direction of the light condenser 40. Therefore, the light condenser 40 can be accurately positioned in the light condenser housing portion 16. The second abutment portions 58B may be urged toward the inner wall portion 17b, instead of the inner wall portion 17a.

### Third Embodiment

A configuration of an image sensor unit 1C of a third embodiment will be described with reference to the drawings.

Although the cover members 70A and 70B are included in the first and second embodiments, the cover member is not included in the third embodiment. An urging member 50C includes holding portions 60C that hold the sensor substrate 45 housed in the substrate housing portion 21 in the case described in the third embodiment. The same reference signs are provided to the same components as in the first and second embodiments, and the description of the same components will not be repeated.

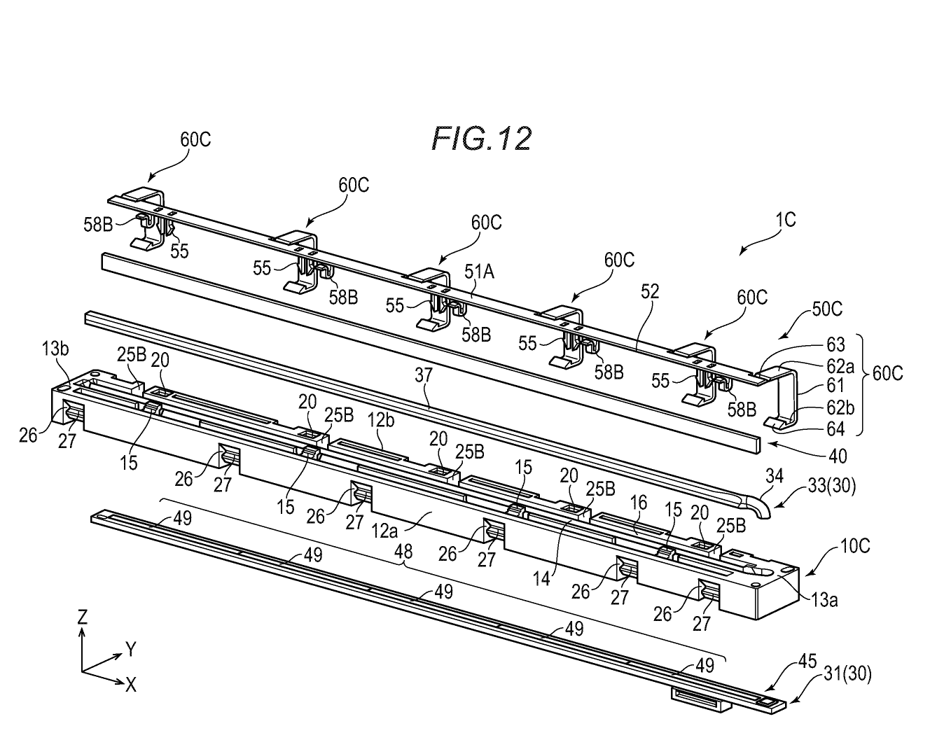

FIG. 12 is an exploded perspective view of the image sensor unit 1C.

The image sensor unit 1C of the present embodiment includes a frame 10C, the illumination portion 30, the light condenser 40, the sensor substrate 45, the image sensor 48, the urging member 50C, and the like.

In the urging member 50C, the holding portions 60C are integrally formed on the other side of the body portion 51A in the sub-scan direction. The holding portions 60C hold the sensor substrate 45 supported by the substrate housing portion 21 of the frame 10C. The holding portion 60C is formed in a substantially C-shape as viewed in the main-scan direction and includes a holding body portion 61, a pair of sandwiching portions 62a and 62b, a hinge portion 63, and a holding piece 64. A plurality of (for example, six) holding portions 60C are formed at intervals in the main-scan direction.

The holding body portion 61 is formed in a planar shape in the vertical direction. The pair of sandwiching portions 62a and 62b are formed to protrude toward one side in the sub-scan direction from the upper and lower ends of the holding body portion 61. The hinge portion 63 is formed between the sandwiching portion 62a and the body portion 51A. The hinge portion 63 is thinner than the other parts, and the holding body portion 61 can be rotated about the hinge portion 63. The holding piece 64 is formed in a hook shape at the tip of the sandwiching portion 62b.

Fitting groove portions 26 and held portions 27 are formed on the frame 10C.

The fitting groove portions 26 are formed on the outer wall portions 12a and 12b, and the pairs of sandwiching portions 62a and 62b of the holding portions 60C are fitted. More specifically, a plurality of (for example, twelve) fitting groove portions 26 are formed at intervals in the main-scan direction in accordance with the holding portions 60C. The dimension (groove width) of the fitting groove portions 26 in the main-scan direction is substantially the same as the dimension of the holding portions 60C in the main-scan direction.

The held portions 27 are formed in the fitting groove portions 26 of the outer wall portion 12a, and the holding pieces 64 of the holding portions 60C are engaged with the held portions 27.

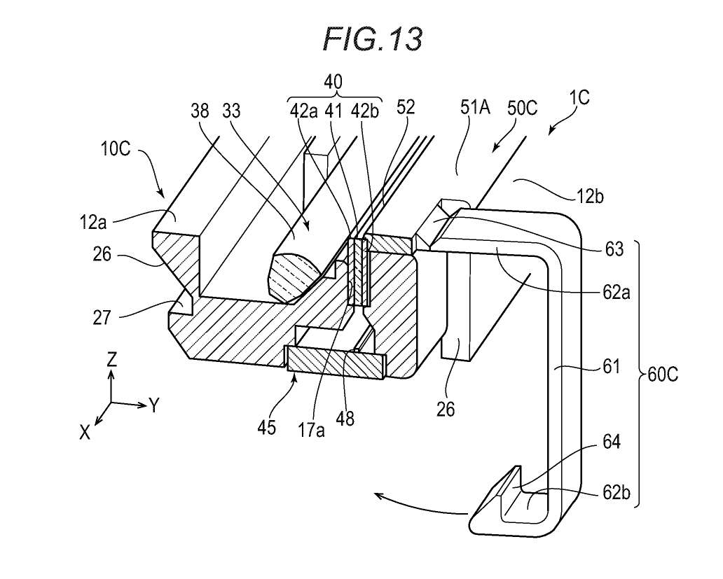

FIG. 13 is a sectional view of a state in which the urging member 50C is mounted on the frame 10C, before the holding portion 60C is fitted to the fitting groove portion 26. As illustrated in FIG. 13, the holding portion 60C is arranged to face the fitting groove portion 26 in the state in which the urging member 50C is mounted on the frame 10C. From the state illustrated in FIG. 13, the holding portion 60C is rotated 90 degrees in an arrow direction about the hinge portion 63, and the holding portion 60C is fitted to the fitting groove portion 26.

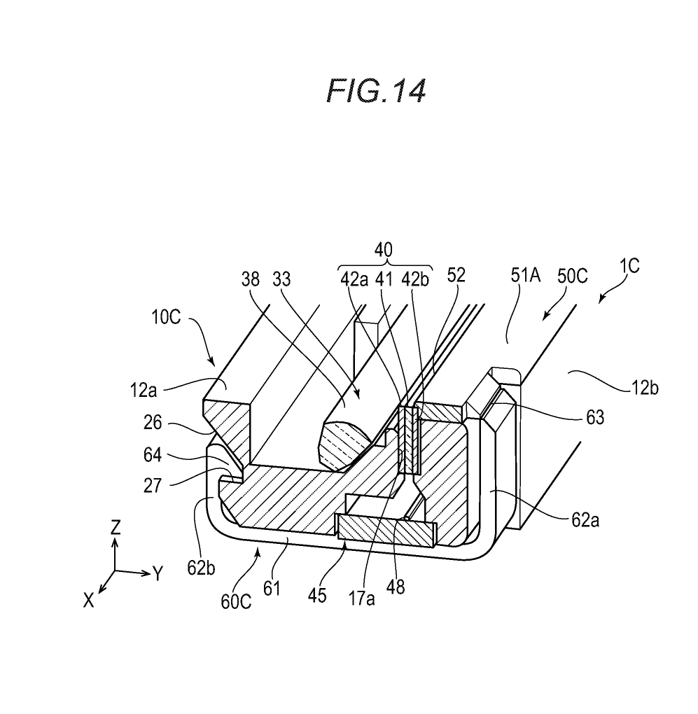

FIG. 14 is a sectional view after the pair of sandwiching portions 62a and 62b of the holding portion 60C are fitted to the fitting groove portion 26. As illustrated in FIG. 14, the pair of sandwiching portions 62a and 62b of the holding portion 60C sandwich the frame 10C from both sides in the sub-scan direction, and the holding piece 64 of the sandwiching portion 62a engages with the held portion 27. In this case, the holding body portion 61 of the holding portion 60 holds the sensor substrate 45 from below. Therefore, the holding portion 60C holds the sensor substrate 45 housed in the substrate housing portion 21.

In this way, according to the image sensor unit 1C of the present embodiment, the urging member 50C includes the holding portions 60C that hold the sensor substrate 45 supported by the frame 10C. Therefore, the cover member can be eliminated, and the number of components can be reduced. The manufacturing cost of the image sensor unit 1C can be reduced.

The holding portions 60C are integrally formed on the urging member 50C through the hinge portions 63. Therefore, the holding portions 60C can be rotated about the hinge portions 63, and the holding portions 60C can be easily engaged with the frame 10C.

The holding portions 60C abut with the frame 10c on both sides of the frame 10c in the lateral direction, and this can prevent the holding portions 60C from falling off from the frame 10C.

### Fourth Embodiment

Although the holding portions 60C are rotated 90 degrees to engage the holding portions 60C with the frame 10C in the third embodiment, holding portions 60D are rotated 180 degrees to engage the holding portions 60D with a frame 10D in the case described in a fourth embodiment. Furthermore, an urging member 50D includes a third abutment portion 66 in the case described in the fourth embodiment. The same reference signs are provided to the same components as in the first to third embodiments, and the description of the same components will not be repeated.

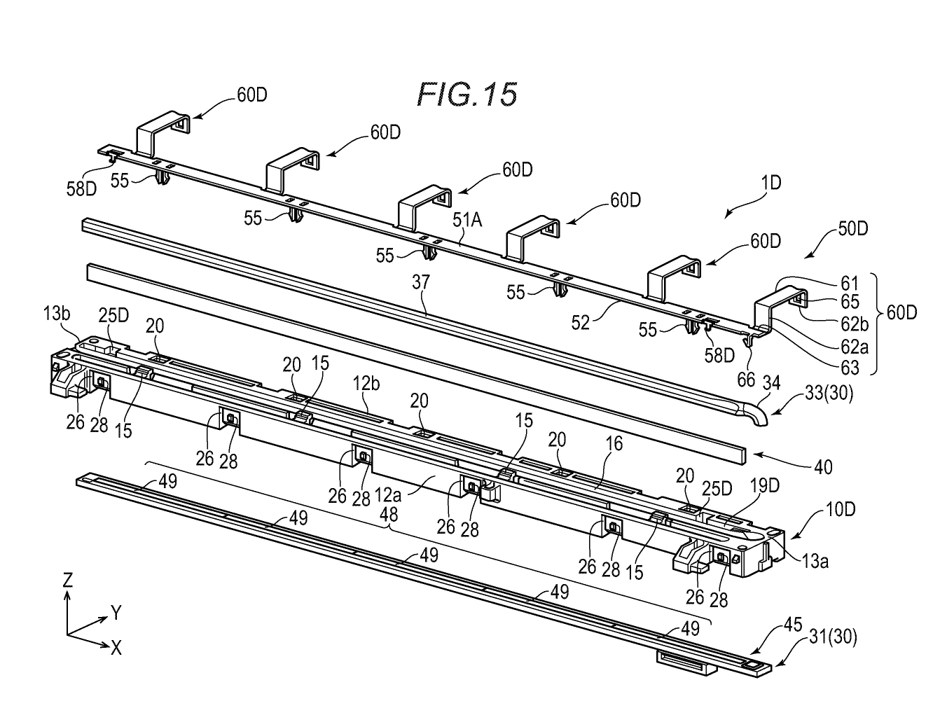

FIG. 15 is an exploded perspective view of an image sensor unit 1D.

The image sensor unit 1D of the present embodiment includes the frame 10D, the illumination portion 30, the light condenser 40, the sensor substrate 45, the image sensor 48, the urging member 50D, and the like.

In the urging member 50D, the holding portions 60D are integrally formed on the other side of the body portion 51A in the sub-scan direction. The holding portion 60D is formed in a substantially C-shape as viewed in the main-scan direction and includes the holding body portion 61, the pair of sandwiching portions 62a and 62b, the hinge portion 63, and a holding hole 65.

Here, the direction of the protrusion of the pair of sandwiching portions 62a and 62b of the holding portion 60D from the holding body portion 61 is downward. The direction is the same as the direction in which the urging member 50D is mounted on the frame 10D, that is, the direction in which the engagement portion 55 protrudes from the body portion 51A.

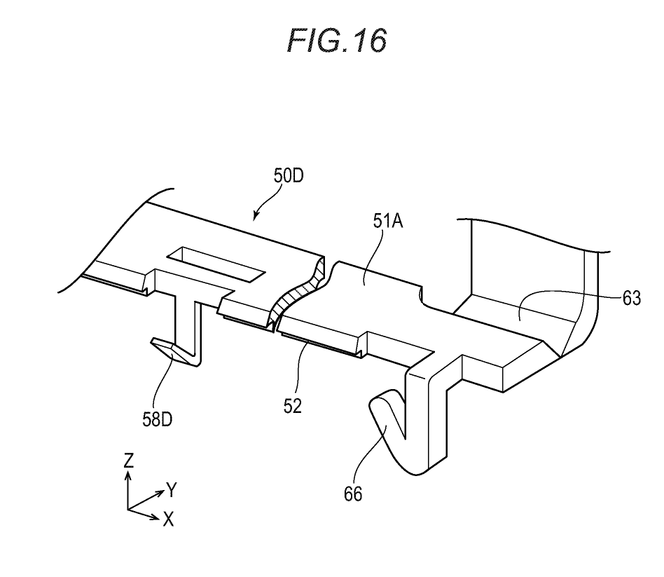

FIG. 16 is an enlarged view of an end on one side of the urging member 50D.

In the urging member 50D, a second abutment portion 58D and the third abutment portion 66 are integrally formed on the body portion 51A. As the urging member 50D is mounted on the frame 10D, the second abutment portion 58D abuts with the outer surface of the plate member 42b of the light condenser 40. The second abutment portions 58D are formed on one side and the other side of the body portion 51A in the main-scan direction. The second abutment portions 58D are bent and formed in the sub-scan direction after protruding downward from the body portion 51A, and the second abutment portions 58D are elastically deformed in the sub-scan direction. Although the function of the second abutment portions 58D of the present embodiment is the same as the second abutment portions 58B of the second embodiment, the number and the shape of the second abutment portions 58D are different.

As the urging member 50D is mounted on the frame 10D, the third abutment portion 66 abuts with the end surface on one side of the light condenser 40 in the main-scan direction. A single third abutment portion 66 is formed on one side in the main-scan direction. The third abutment portion 66 is bent toward the other side in the main-scan direction after protruding downward from the body portion 51A, and the third abutment portion 66 is elastically deformed in the main-scan direction.

In the frame 10D, held portions 28 for engaging the holding holes 65 of the holding portions 60D protrude and are formed in the fitting groove portions 26. In the frame 10D, insertion holes 25D for inserting the second abutment portions 58D of the urging member 50D are formed on one side and the other side in the main-scan direction. An insertion hole 19D for inserting the third abutment portion 66 is formed at a position close to the light condenser housing portion 16 of the frame 10D and the side wall portion 13a on one side. A single insertion hole 19D is formed, and the insertion hole 19D communicates with the light condenser housing portion 16.

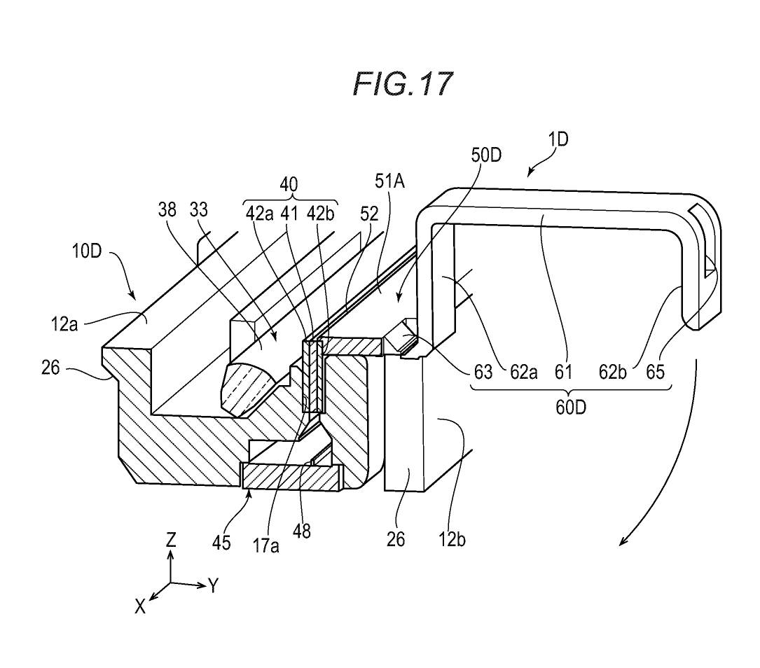

FIG. 17 is a sectional view of a state in which the urging member 50D is mounted on the frame 10D, before the holding portion 60D is fitted to the fitting groove portion 26. As illustrated in FIG. 17, the holding portion 60D is arranged to face the fitting groove portion 26 when the urging member 50D is mounted on the frame 10D. From the state illustrated in FIG. 17, the holding portion 60D is rotated 180 degrees in an arrow direction about the hinge portion 63, and the holding portion 60D is fitted to the fitting groove portion 26.

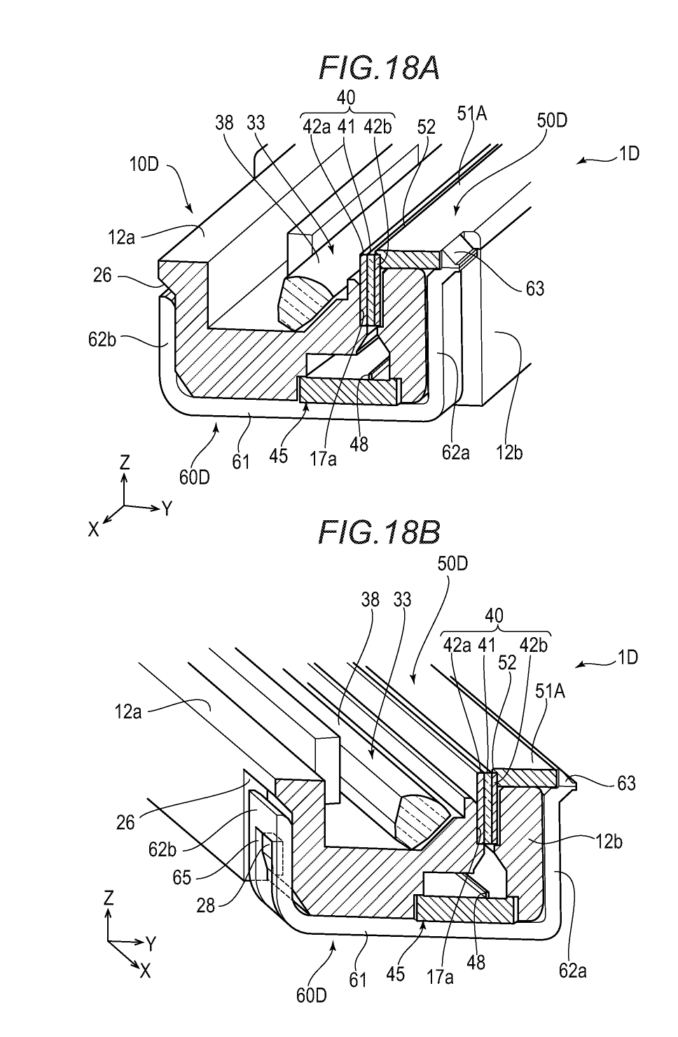

FIGS. 18A and 18B are sectional views after the pair of sandwiching portions 62a and 62b of the holding portion 60D are fitted to the fitting groove portion 26. As illustrated in FIG. 18A, the pair of sandwiching portions 62a and 62b of the holding portion 60D sandwich the frame 10D from both sides in the sub-scan direction. As illustrated in FIG. 18B, the holding hole 65 of the sandwiching portion 62a engages with the held portion 28.

The third abutment portion 66 abuts with the end surface on one side of the light condenser 40 and urges the light condenser 40 toward the side wall portion 13b of the frame 10D. Therefore, the light condenser 40 is pressed against the side wall portion 13b and housed in the light condenser housing portion 16.

In this way, according to the image sensor unit 1D of the present embodiment, the direction of the protrusion of the sandwiching portions 62a and 62b of the urging member 50D and the direction of the protrusion of the engagement portions 55 are the same direction. Therefore, the direction of demolding can be one direction in the injection molding of the urging member 50D, and a relatively simple mold can be used. The manufacturing cost of the urging member 50D can be reduced.

The third abutment portion 66 is formed on the urging member 50D to urge the light condenser 40 to the frame 10D from one side of the light condenser 40 in the longitudinal direction. Therefore, the light condenser 40 can be accurately positioned in the light condenser housing portion 16. The third abutment portion 66 may be urged toward the side wall portion 13a, instead of the side wall portion 13b.

### Fifth Embodiment

Although a plurality of engagement portions 55 are integrally formed on the body portion 51A to use one of the urging members 50A to 50D in the cases described in the first to fourth embodiments, a plurality of urging members 50E are used in the case described in a fifth embodiment. A plurality of holding members 80E are also used to hold the sensor substrate 45 housed in the substrate housing portion 21 in the description of the case. The same reference signs are provided to the same components as in the first to fourth embodiments, and the description of the same components will not be repeated.

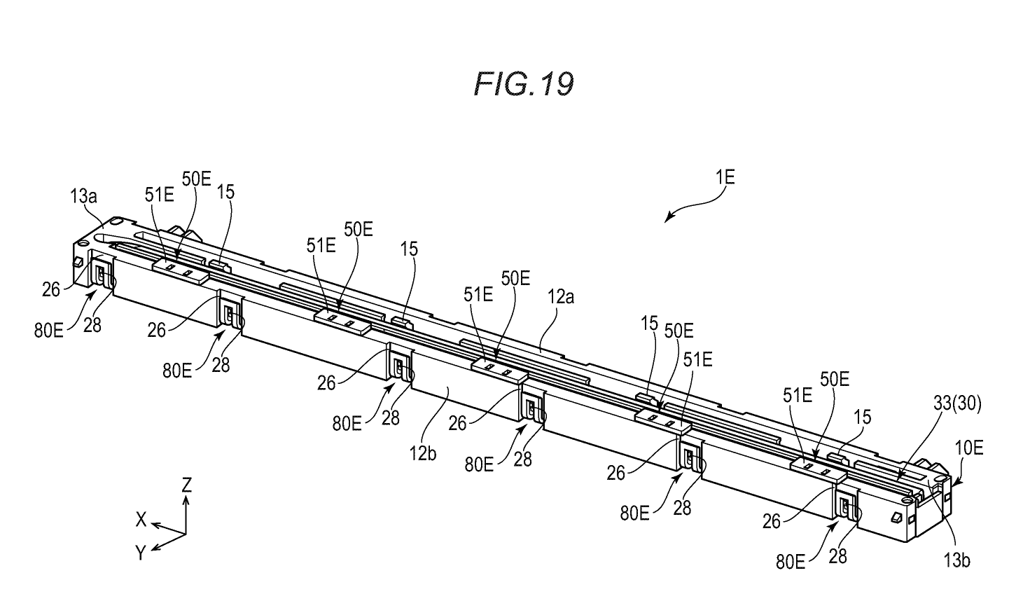

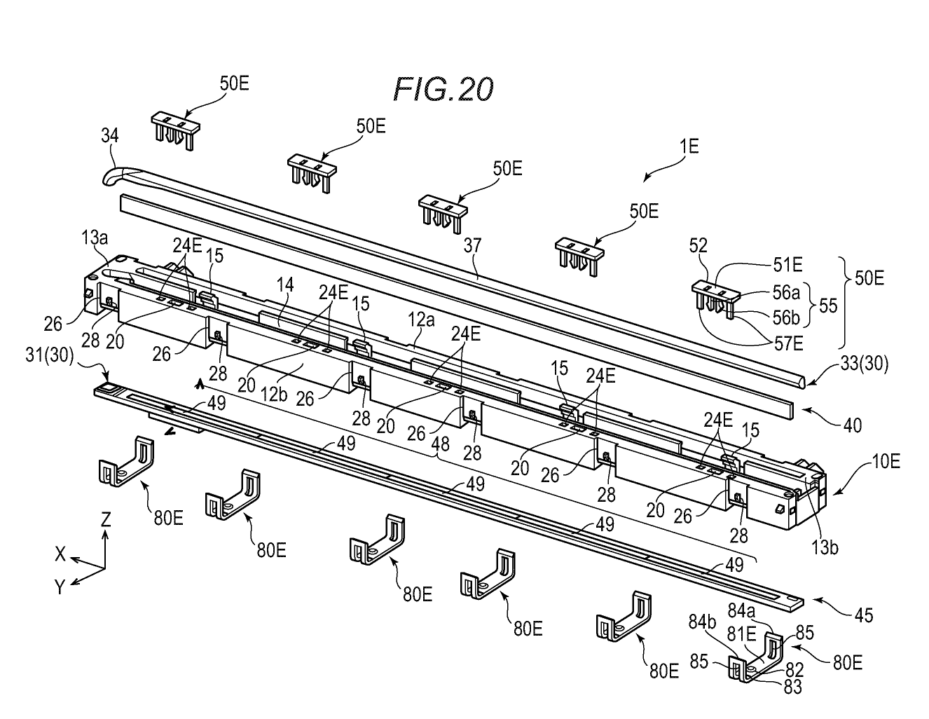

FIG. 19 is an external perspective view of an image sensor unit 1E. FIG. 20 is an exploded perspective view of the image sensor unit 1E. FIGS. 19 and 20 are perspective views of the image sensor unit 1E from the other side in the sub-scan direction.

The image sensor unit 1E of the present embodiment includes a frame 10E, the illumination portion 30, the light condenser 40, the sensor substrate 45, the image sensor 48, the urging members 50E, the holding members 80E, and the like.

The urging member 50E includes a body portion 51E, the engagement portion 55, and positioning pieces 57E.

The body portion 51E has a planar shape in the main-scan direction, and the first abutment portion 52 that abuts with the light condenser 40 is formed at the end on one side in the sub-scan direction. The engagement portion 55 and the positioning pieces 57E are integrally formed on the lower surface of the body portion 51E.

The positioning pieces 57E are inserted into positioning holes 24E of the frame 10E. Here, two positioning pieces 57E are formed across the engagement portion 55, at an interval in the main-scan direction.

In the image sensor unit 1E of the present embodiment, a plurality of (for example, five) urging members 50E are mounted on the frame 10E at intervals in the main-scan direction.

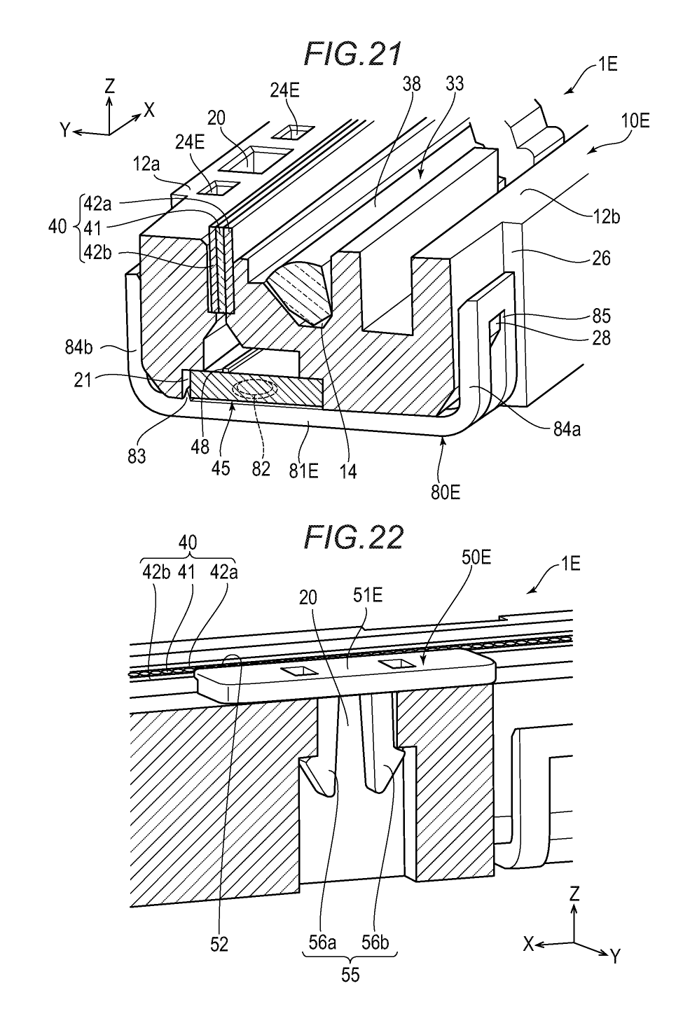

The holding members 80E hold the sensor substrate 45 supported by the frame 10E. The holding member 80E is formed in a substantially C-shape as viewed in the main-scan direction and includes a holding body portion 81E, a pair of sandwiching portions 84a and 84b, and holding holes 85. The holding body portion 81E is planar, and a circular pressing projection 82 protruding from the upper surface is formed. In the holding body portion 81E, a wedge-shaped substrate alignment portion 83 protruding from the upper surface is also formed in the main-scan direction (see also FIG. 21).

The pair of sandwiching portions 84a and 84b are formed to protrude upward from both sides of the holding body portion 81E. The holding hole 85 is formed on each of the pair of sandwiching portions 84a and 84b.

In the frame 10E, the positioning holes 24E are formed in a concave shape from the upper side, on both sides of the engaged portions 20 in the main-scan direction.

FIG. 21 is a sectional view cut in the sub-scan direction of the holding member 80E mounted on the frame 10E. As illustrated in FIG. 21, the pair of sandwiching portions 84a and 84b of the holding member 80E are fitted to the fitting groove portion 26 of the frame 10E to sandwich the frame 10E from both sides in the sub-scan direction. The holding holes 85 of the sandwiching portions 84a and 84b engage with the held portion 28. Therefore, as all of the holding members 80E are mounted on the frame 10E, the holding members 80E hold the sensor substrate 45 housed in the substrate housing portion 21.

When the holding member 80E is mounted on the frame 10E, the pressing projection 82 of the holding member 80E urges the lower surface of the sensor substrate 45 housed in the substrate housing portion 21 upward. The substrate alignment portion 83 comes into touch with the side end on the other side of the sensor substrate 45 in the sub-scan direction to press the sensor substrate 45 toward one side in the sub-scan direction in the substrate housing portion 21. Therefore, the sensor substrate 45 can be accurately positioned in the substrate housing portion 21. The substrate alignment portion 83 may press the sensor substrate 45 toward the other side, instead of one side in the sub-scan direction.

FIG. 22 is a sectional view cut in the main-scan direction of the urging member 50E mounted on the frame 10E. As illustrated in FIG. 22, the engagement portion 55 of the urging member 50E engages with the engaged portion 20 of the frame 10E. As the urging member 50E is mounted on the frame 10E, the first abutment portion 52 of the urging member 50E abuts with the upper surface of the plate member 42b of the light condenser 40. As all of the urging members 50E are mounted on the frame 10E, the urging members 50E hold the light condenser 40 housed in the light condenser housing portion 16.

In this way, according to the image sensor unit 1E of the present embodiment, a plurality of urging members 50E that urge and fix the light condenser 40 are included. Therefore, the urging members 50E can be downsized, and the manufacturing cost can be reduced.

The plurality of urging members 50E are arranged at intervals in the main-scan direction, and the light condenser 40 can be urged toward the frame 10 in a balanced manner. This can prevent the light condenser 40 from falling off from the frame 10E.

A plurality of holding members 80E separated from the urging members 50E are also included. Therefore, the holding members 80E can be downsized, and the manufacturing cost can be reduced.

### Sixth Embodiment

Although the urging members 50E and the holding members 80E are used in the case described in the fifth embodiment, urging members 50F and holding members 80F are used in the case described in a sixth embodiment. The same reference signs are provided to the same components as in the first to fifth embodiments, and the description of the same components will not be repeated.

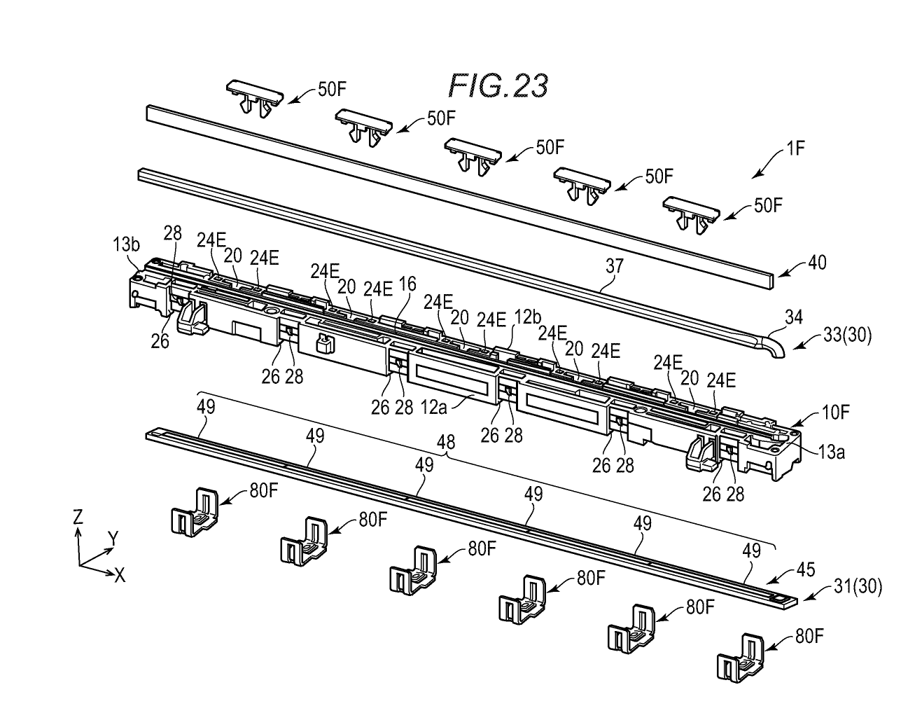

FIG. 23 is an exploded perspective view of an image sensor unit 1F. FIG. 23 is a perspective view of the image sensor unit 1F from one side in the sub-scan direction.

The image sensor unit 1F of the present embodiment includes a frame 10F, the illumination portion 30, the light condenser 40, the sensor substrate 45, the image sensor 48, the urging members 50F, the holding members 80F, and the like.

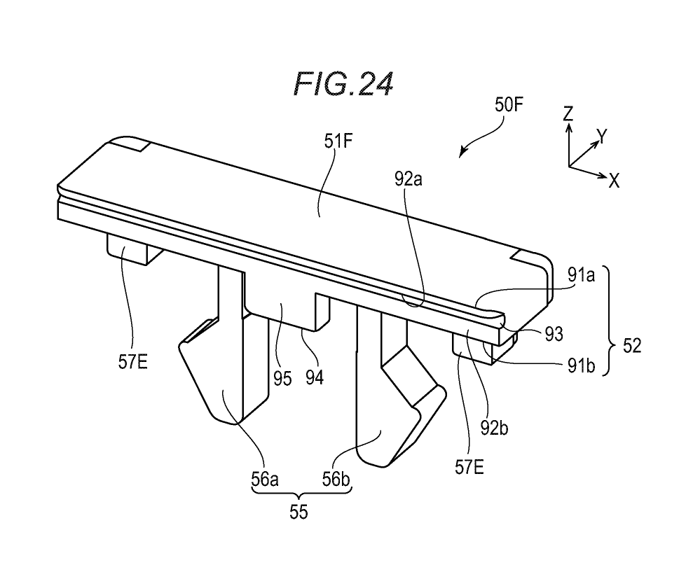

FIG. 24 is a perspective view of the urging member 50F.

The urging member 50F includes a body portion 51F, the engagement portion 55, and the positioning piece 57E.

The body portion 51F has a planar shape in the main-scan direction, and the first abutment portion 52 that abuts with the light condenser 40 is formed at the end on one side in the sub-scan direction. The first abutment portion 52 includes a first support portion 91a coming into contact with the upper surface of the plate member 42b in the light condenser 40 and a second support portion 91b coming into contact with the outer surface of the plate member 42b. The first support portion 91a comes into contact with the upper surface of the light condenser 40 through a first support surface 92a, and the second support portion 91b comes into contact with the outer surface of the light condenser 40 through a second support surface 92b. The first support surface 92a and the second support surface 92b are orthogonal to each other. A concave portion 93 dug toward the inside of the body portion 51F is formed between the first support surface 92a and the second support surface 92b. When the urging member 50F is manufactured by injection molding, a slightly outward swell is generated between the first support surface 92a and the second support surface 92b due to the characteristics of the mold, and molding of an orthogonal corner is difficult in some cases. Therefore, the formation of the concave portion 93 can perform molding without the generation of the outward swell between the first support surface 92a and the second support surface 92b.

The body portion 51F also includes a wall portion 94 integral with the lower end of the second support portion 91b and protruding downward from the center in the main-scan direction. A wall surface 95 continuous with the second support surface 92b is formed on the wall portion 94.

On the other hand, as illustrated in FIG. 23, the inner wall portion 17b is not formed on part of the positions adjacent to the engaged portions 20 in the light condenser housing portion 16 of the frame 10F, and the light condenser housing portion 16 and the engaged portions 20 communicate with each other.

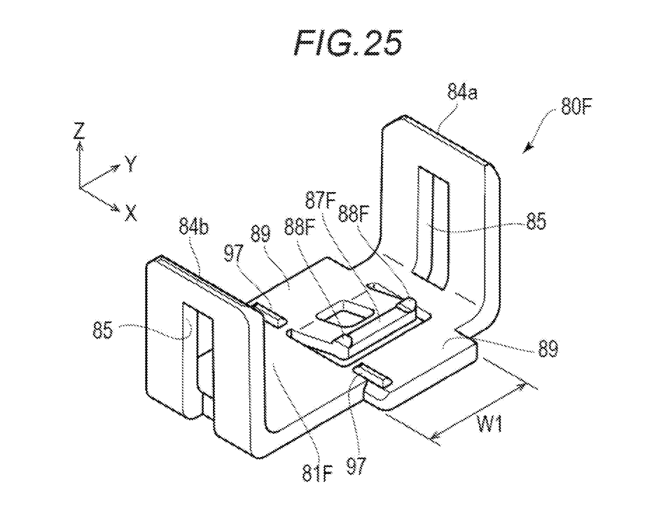

FIG. 25 is a perspective view of the holding member 80F.

The holding member 80F holds the sensor substrate 45 supported by the frame 10E. In a holding body portion 81F of the holding member 80F, a substrate urging portion 87F protruding upward is integrally formed at substantially the center, more specifically, at a position slightly biased to the other side in the sub-scan direction. The substrate urging portion 87F is elastically deformed in the vertical direction. Two projections 88F and 88F protruding upward are formed at the tips of the substrate urging portion 87F, at positions separated in the sub-scan direction. The holding body portion 81F includes two interval holding portions 89 extended by a width dimension W1 from both ends in the main-scan direction. Projections 97 protruding upward are formed on the upper surfaces of the two interval holding portions 89. Here, one of the projections 88F of the substrate urging portion 87F and the two projections 97 on the upper surfaces of the interval holding portions 89 are arranged substantially side by side in the main-scan direction when the holding member 80F is viewed from above.

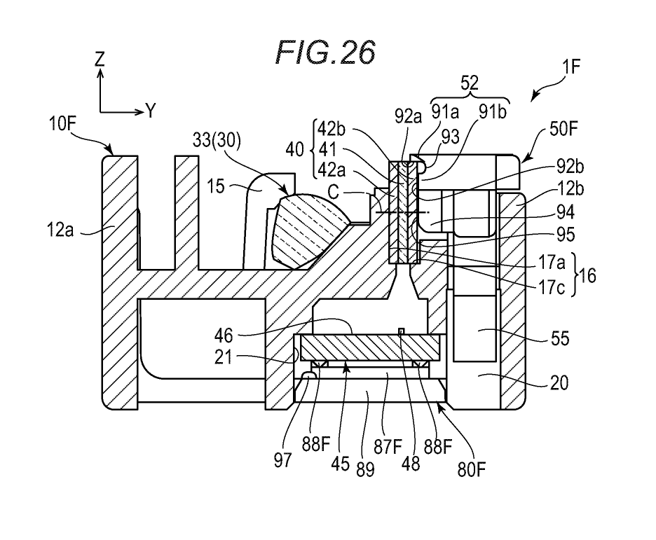

FIG. 26 is a sectional view cut in the sub-scan direction of the urging member 50F and the holding member 80F mounted on the frame 10F. As illustrated in FIG. 26, the urging member 50F is mounted on the frame 10F, and the first abutment portion 52 of the urging member 50F abuts with the plate member 42b of the light condenser 40. Specifically, the first support surface 92a of the first support portion 91a abuts with the upper surface of the plate member 42b of the light condenser 40, and the second support surface 92b of the second support portion 91b abuts with the outer surface of the plate member 42b. In this case, the wall surface 95 of the wall portion 94 also abuts with the outer surface of the plate member 42b. As illustrated in FIG. 26, the wall surface 95 abuts with the light condenser 40 across a center C in the vertical dimension of the light condenser 40, and the light condenser 40 is supported in the light condenser housing portion 16 without an inclination. As the concave portion 93 not in contact with the light condenser 40 is formed, the urging member 50F can be molded without the generation of an outward swell between the first support surface 92a and the second support surface 92b, and the second support portion 91b and the wall portion 94 can abut with the light condenser 40.

As the holding members 80F are mounted on the frame 10F, the substrate urging portions 87F urge the lower surface of the sensor substrate 45 housed in the substrate housing portion 21 upward through the projections 88F and 88F. In this case, the projections 88F and 88F urge the sensor substrate 45 at positions away from the position directly under the image sensor 48, and this can prevent imposing a load on the image sensor 48. The mounting surface 46 of the sensor substrate 45 and the frame 10F come into contact with the upper sides of the projections 88F and 88F, and the rigid frame 10F can receive the urging force of the substrate urging portions 87F. There is assumed a case in which an impact is applied to the image sensor unit 1F, and the sensor substrate 45 moves downward against the urging force of the substrate urging portions 87F. In this case, the projections 97 in the holding body portions 81F away from the positions directly under the image sensor 48 restrict the movement of the sensor substrate 45, and this can prevent imposing a load on the image sensor 48.

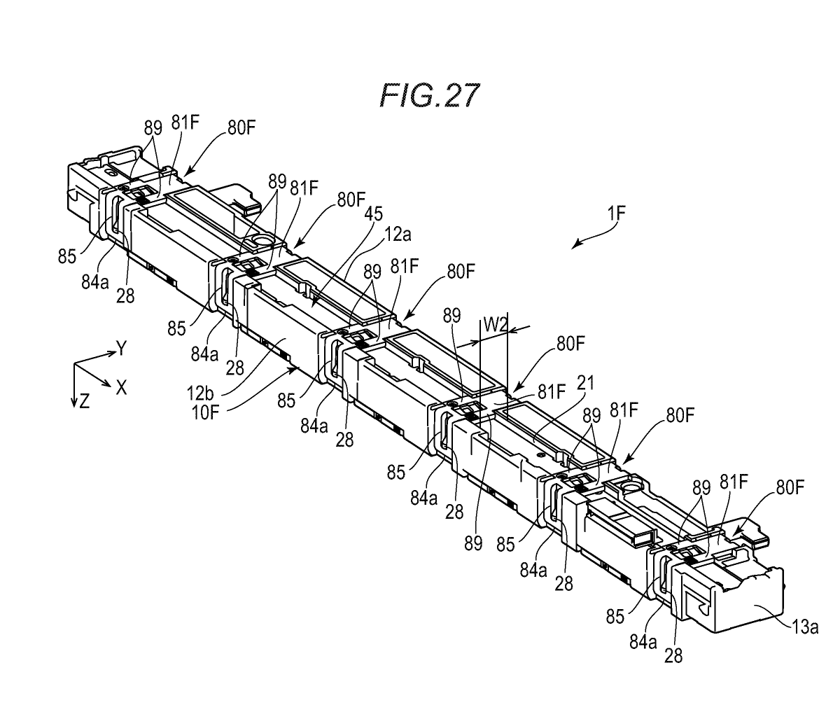

FIG. 27 is a perspective view of the lower side of the image sensor unit 1F. As illustrated in FIG. 27, the holding members 80F are mounted on the frame 10F, and the interval holding portions 89 are fitted into the grooves in the main-scan direction of the substrate housing portion 21. A width dimension W2 of the grooves in the main-scan direction of the substrate housing portion 21 is substantially the same as or slightly larger than the width dimension W1 of the interval holding portions 89.

Here, a case in which the image sensor unit 1F has fallen will be assumed. In this case, due to the impact of the fall, the outer wall portion 12a and the outer wall portion 12b may be temporarily deformed in the directions approaching each other on the lower side of the frame 10F, and on the other hand, the outer wall portion 12a and the outer wall portion 12b may be temporarily deformed in directions away from each other on the upper side of the frame 10F. In this case, the abutment between the light condenser 40 and the first abutment portion 52 may be removed, and the light condenser 40 may be separated from the light condenser housing portion 16. In the present embodiment, even when the impact is applied to the frame 10F, the interval holding portions 89 are fitted into the grooves of the substrate housing portion 21, and this can prevent the deformation in the directions in which the width dimension of the grooves of the substrate housing portion 21 is reduced. More specifically, the deformation on the lower side of the frame 10 can be prevented to prevent the deformation in the directions in which the outer wall portion 12a and the outer wall portion 12b approach each other on the lower side of the frame 10F and the deformation in the directions in which the outer wall portion 12a and the outer wall portion 12b are separated from each other on the upper side of the frame 10F. This can prevent the separation of the light condenser 40 from the light condenser housing portion 16.

In this way, according to the image sensor unit 1F of the present embodiment, the urging member 50F includes the concave portion 93 between the first support portion 91a and the second support portion 91b, and the urging member 50F can be molded without the generation of an outward swell between the first support portion 91a and the second support portion 91b. Therefore, the first support portion 91a and the second support portion 91b can abut with the light condenser 40.

### Seventh Embodiment

Although the urging members 50F and the holding members 80F are used in the case described in the sixth embodiment, urging members 50G and holding members 80G are used in the case described in a seventh embodiment. The same reference signs are provided to the same components as in the first to sixth embodiments, and the description of the same component will not be repeated.

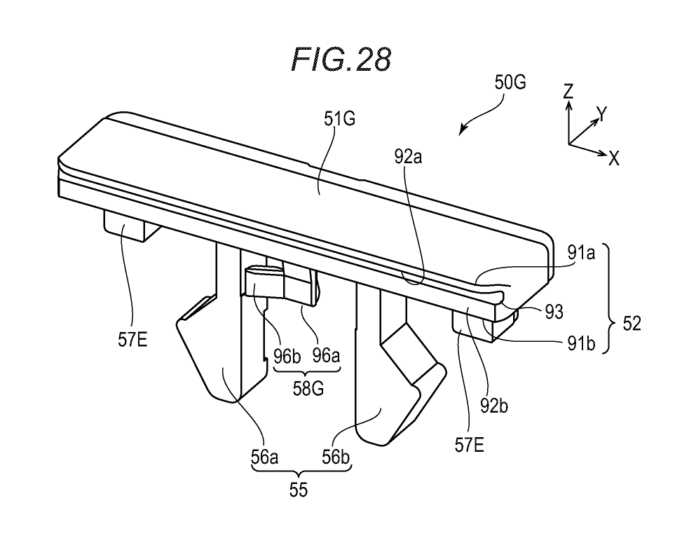

FIG. 28 is a perspective view of the urging member 50G.

A body portion 51G of the urging member 50G includes a second abutment portion 58G integrally protruding downward from the lower end of the second support portion 91b at the center in the main-scan direction. The second abutment portion 58G is formed in a substantially L-shape and includes: an arm portion 96a protruding downward from the second support portion 91b to allow easy elastic deformation; and a tip portion 96b bent from the arm portion 96a in the main-scan direction. The tip portion 96b is arranged inside of an extended surface that is a downward extension of the second support surface 92b as viewed in the main-scan direction, that is, at a position not exceeding the extended surface in the direction of one side in the sub-scan direction.

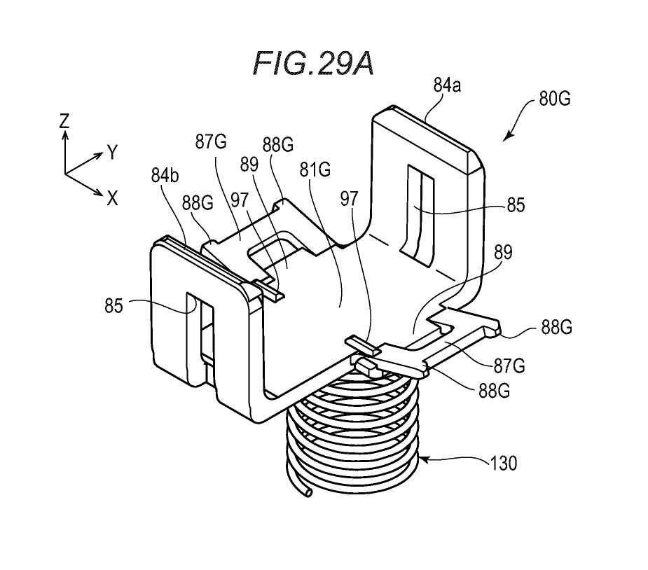

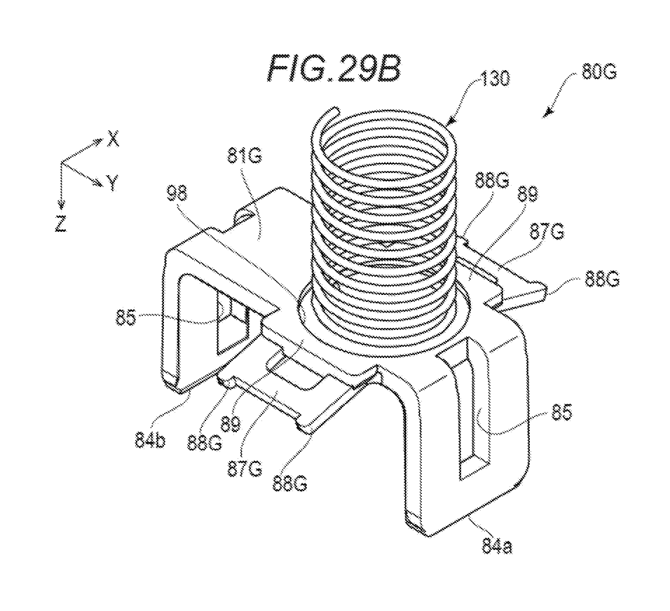

FIG. 29A is a perspective view of the holding member 80G from above. FIG. 29B is a perspective view of the holding member 80G from below.

A holding body portion 81G of the holding member 80G includes the interval holding portions 89 on both sides in the main-scan direction. In the holding body portion 81G, two substrate urging portions 87G obliquely protruding upward are integrally formed at positions close to the interval holding portions 89. The two substrate urging portions 87G extend from the holding body portion 81G in directions away from each other in the main-scan direction and are elastically deformed in the vertical direction. Two projections 88G and 88G are formed at the tips of the substrate urging portions 87G, at positions away from each other in the sub-scan direction. As illustrated in FIG. 29B, a placement portion 98 circularly dug to place one end of a coil spring 130 as an elastic body is formed on the lower surface of the holding body portion 81G. The coil spring 130 urges an image sensor unit 1G toward the platen glass 104 (FIG. 1) through the holding member 80G.

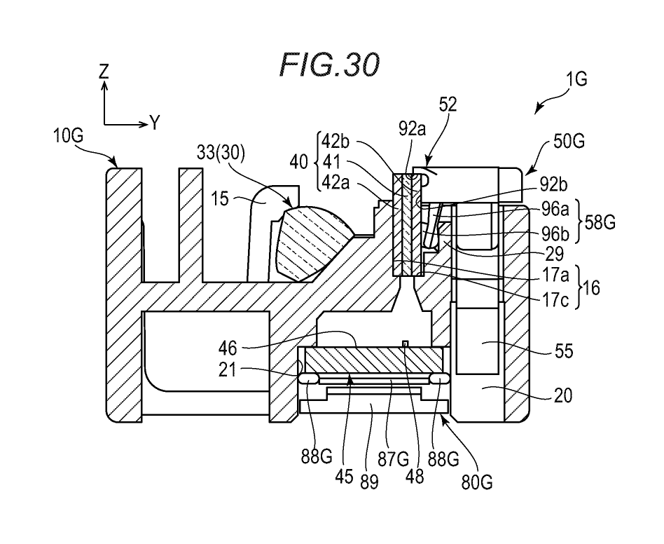

FIG. 30 is a sectional view cut in the sub-scan direction of the image sensor unit 1G including the urging members 50G and the holding members 80G mounted on a frame 10G. Here, the frame 10G includes a pressing wall 29 facing the inner wall portion 17a, in which part of the inner wall portion 17b adjacent to the engaged portions 20 in the light condenser housing portion 16 is recessed.

As illustrated in FIG. 30, the urging member 50G is mounted on the frame 10G, and the first abutment portion 52 of the urging member 50G abuts with the plate member 42b of the light condenser 40. The arm portion 96a of the second abutment portion 58G of the urging member 50G is pressed by the pressing wall 29 and swings toward the light condenser 40. In this case, although the arm portion 96a does not come into contact with the light condenser 40, the tip portion 96b moves closer to the light condenser 40 beyond the extended surface that is a downward extension of the second support surface 92b, according to the swing of the arm portion 96a. Therefore, the moved tip portion 96b urges the light condenser 40 to the inner wall portion 17a in the light condenser housing portion 16.

As the holding members 80G are mounted on the frame 10G, the substrate urging portions 87G urge the lower surface of the sensor substrate 45 housed in the substrate housing portion 21 upward through the projections 88G and 88G. In this case, the two substrate urging portions 87G separated in the main-scan direction urge the sensor substrate 45, and the sensor substrate 45 with the main-scan direction as a longitudinal direction can be urged at positions at intervals from the sensor substrate 45.

In this way, according to the image sensor unit 1G of the present embodiment, the urging members 50G include the second abutment portions 58G pressed by the pressing wall 29 of the frame 10G. Therefore, the urging members 50G can be mounted on the frame 10G without interference with the light condenser 40, and the light condenser 40 can be urged toward the inner wall portion 17a of the light condenser housing portion 16 when the urging members 50G are mounted.

Although the tip portion 96b of the urging member 50G is arranged at a position inside of the extended surface that is a downward extension of the second support surface 92b in the description, the tip portion 96b may be positioned outside of the extended surface instead of this. In this case, the pressing wall 29 of the frame 10G can be eliminated.

When a plurality of urging members 50G are used to fix the frame 10G to the light condenser 40, only the engaged portions 20 mounted with the urging members 50G positioned on both sides in the main-scan direction among the plurality of urging members 50G may include the pressing wall 29, and the engaged portions 20 and the light condenser housing portion 16 may communicate with each other in the engaged portions 20 mounted with the other urging members 50G.

### Eighth Embodiment

Although the urging members 50F and the holding members 80F as well as the urging members 50G and the holding members 80G are separate in the cases described in the sixth and seventh embodiments, holding portions 80H are integrally formed on urging members 50H in the case described in an eighth embodiment. The same reference signs are provided to the same components as in the first to seventh embodiments, and the description of the same components will not be repeated.

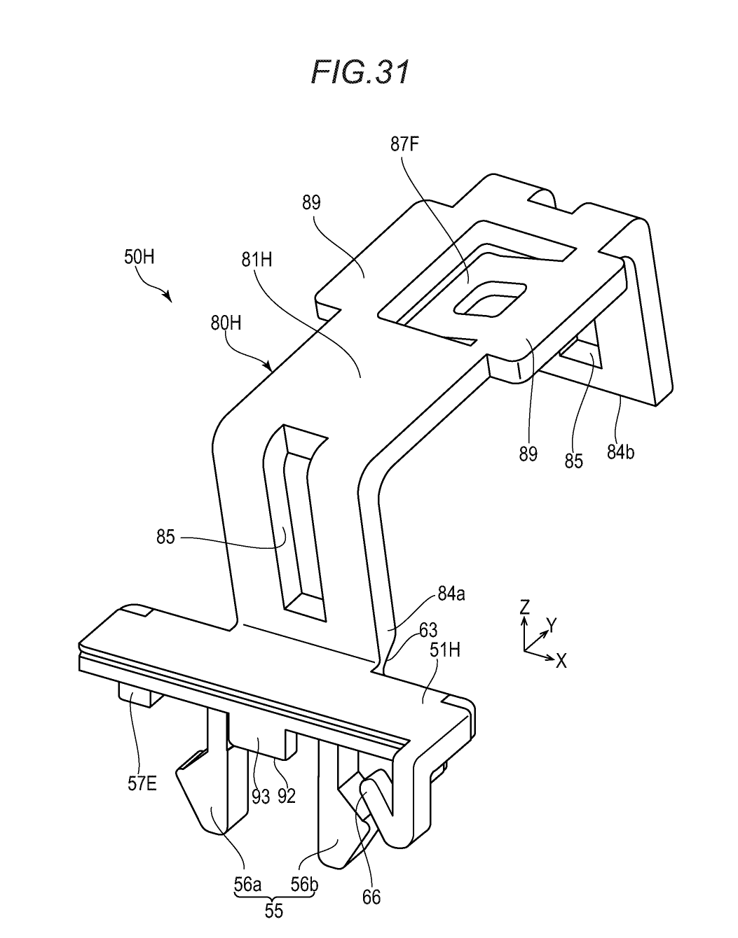

FIG. 31 is a perspective view of the urging member 50H.

A body portion 51H of the urging member 50H includes the third abutment portion 66. As the urging member 50H is mounted on the frame, the third abutment portion 66 abuts with the end surface on one side of the light condenser 40 in the main-scan direction and urges the light condenser 40 toward the side wall portion 13b of the frame. When a plurality of urging members 50H are used to fix the light condenser 40 to the frame, it is preferable to form the third abutment portion 66 only on the urging member 50H arranged on the extreme end among the plurality of urging members 50H, and the other urging members 50H do not include the third abutment portion 66.

The holding portion 80H is connected to the body portion 51H of the urging member 50H through the hinge portion 63. Therefore, the holding portion 80H can be rotated through the hinge portion 63. As the holding portion 80H is rotated, the holding hole 85 of the sandwiching portions 84a and 84b can be engaged with the held portion 28 of the frame to hold the sensor substrate 45 supported by the frame.

In this way, the urging members 50H include the integrated holding portions 80H. Therefore, the number of components can be reduced, and the manufacturing cost of the image sensor unit can be reduced.

The shape of the body portions 51H of the urging members 50H may not be the same as the shape of the body portions 51F of the sixth embodiment. The shape of the body portions 51H may be the same as the shape of the body portions 51G of the seventh embodiment. The shape of the holding portions 60H may not be the same as the shape of the holding members 80F of the sixth embodiment. The shape of the holding portions 60H may be the same as the shape of the holding members 80G of the seventh embodiment.

Although the present invention has been described along with the embodiments, the present invention is not limited to the embodiments. Changes and the like can be made within the scope of the present invention, and the embodiments may be appropriately combined.

Although the curved portion 34 and the linear portion 37 are integrally formed on the light guide 33 in the description of the embodiments, a light guide including only the linear portion 37 may be used instead of this. When the light guide including only the linear portion 37 is used, the incident surface of the light guide is orthogonal to the main-scan direction. Therefore, the light source is arranged to face the incident surface of the light guide such that the light emission surface is orthogonal to the main-scan direction.

Although the illumination portion 30 includes the light source 31 and the light guide 33 in the description of the present embodiments, the arrangement is not limited to this. For example, as in an LED array, the light sources 31 may be arranged in the main-scan direction to linearly illuminate the original P.

Although each image sensor unit includes the illumination portion 30 in the description of the present embodiments, the arrangement is not limited to this. The image sensor unit may not include the illumination portion 30.

The pressing projections 82 of the holding members 80E described in the fifth embodiment can be formed on the cover members 70A and 70B, the holding portions 60C of the urging members 50C, and the holding portions 60D of the urging members 50D. The substrate alignment portions 83 of the holding members 80E described in the fifth embodiment can be formed on the cover members 70A and 70B, the holding portions 60C of the urging members 50C, and the holding portions 60D of the urging members 50D.

Although the engagement portions 55 of the urging members 50A to 50E are elastically deformed, and the engaged portions 20 of the frames 10A to 10G are not elastically deformed in the description of the first to eighth embodiments, the arrangement is not limited to this. More specifically, it is only necessary that at least either the engagement portions 55 or the engaged portions 20 are elastically deformed, and the engagement portions 55 are engaged with the engaged portions 20.

### INDUSTRIAL APPLICABILITY

The present invention can be used in an image sensor unit, an image reading apparatus, and an image forming apparatus.

1. An image sensor unit comprising:
a light condenser that condenses light including image information of an illuminated object;
an image sensor that receives the light passed through the light condenser and that converts the light to an electrical signal; and
a frame that houses the light condenser and the image sensor, wherein
the image sensor unit comprises an urging member that urges and fixes the light condenser to the frame, and
the urging member urges and fixes the light condenser to the frame from a light entering side or a light emission side of the light.

2. The image sensor unit according to claim 1, wherein
the urging member urges and fixes the light condenser to the frame at a position not obstructing an optical path of the light condenser.

3. The image sensor unit according to claim 1, wherein
the urging member comprises an engagement portion,
the frame comprises an engaged portion engaged with the engagement portion, and
the urging member is detachably engaged with the frame.

4. The image sensor unit according to claim 1, wherein
the urging member urges the light condenser to the frame from one side in a lateral direction orthogonal to both an optical axis direction and a longitudinal direction of the light condenser.

5. The image sensor unit according to claim 1, wherein
the image sensor unit comprises a plurality of the urging members that urge the light condenser.

6. The image sensor unit according to claim 5, wherein the plurality of urging members are arranged at intervals in the longitudinal direction of the light condenser.

7. The image sensor unit according to claim 1, wherein
the urging member comprises a first support portion and a second support portion orthogonal to the first support portion, the first support portion and the second support portion abutted to the light condenser, and
a concave portion is included between the first support portion and the second support portion.

8. The image sensor unit according to claim 1, wherein
the urging member urges the light condenser to the frame from one side of the light condenser in the longitudinal direction of the light condenser.

9. The image sensor unit according to claim 1, further comprising
a sensor substrate mounted with the image sensor and supported by the frame, wherein the urging member comprises a holding portion that holds the sensor substrate supported by the frame.

10. The image sensor unit according to claim 9, wherein
the holding portion is integrally formed on the urging member through a hinge portion.

11. The image sensor unit according to claim 9, wherein
the holding portion abuts with the frame on both sides in a sub-scan direction.

12. An image reading apparatus comprising:
an image sensor unit; and
a housing houses the image sensor unit, wherein
the image sensor unit comprises a light condenser that condenses light including image information of an illuminated object;
an image sensor that receives the light passed through the light condenser and that converts the light to an electrical signal; and
a frame that houses the light condenser and the image sensor, wherein
the image sensor unit comprises an urging member that urges and fixes the light condenser to the frame, and
the urging member urges and fixes the light condenser to the frame from a light entering side or a light emission side of the light.

13. An image forming apparatus comprising:
an image sensor unit; and
an image forming portion that forms, in a recording medium, an image read by the image sensor unit, wherein
the image sensor unit comprises a light condenser that condenses light including image information of an illuminated object;
an image sensor that receives the light passed through the light condenser and that converts the light to an electrical signal; and
a frame that houses the light condenser and the image sensor, wherein
the image sensor unit comprises an urging member that urges and fixes the light condenser to the frame, and
the urging member urges and fixes the light condenser to the frame from a light entering side or a light emission side of the light.
